(19) United States
(12) Patent Application Publication
(10) Pub. No.: US 2023/0017337 A1
(43) Pub. Date: Jan. 19, 2023

(54) DUAL PULSED POWER SYSTEM WITH INDEPENDENT VOLTAGE AND TIMING CONTROL AND REDUCED POWER CONSUMPTION

(71) Applicant: Cymer, LLC, San Diego, CA (US)

(72) Inventors: Paul Christopher Melcher, El Cajon, CA (US); Thomas Patrick Duffey, San Diego, CA (US); Walter Dale Gillespie, San Diego, CA (US)

(21) Appl. No.: 17/788,370

(22) PCT Filed: Dec. 11, 2020
(86) PCT No.: PCT/US2020/064634

§ 371 Date: Jun. 23, 2022

Related U.S. Application Data
(60) Provisional application No. 62/955,620, filed on Dec. 31, 2019.

(51) Int. Cl. H01S 3/097; H01S 3/23; H01S 3/104; H01S 3/10

(52) U.S. Cl. CPC H01S 3/09702; H01S 3/2308; H01S 3/104; H01S 3/10046

(57) ABSTRACT

Systems, apparatuses, methods, and computer program products are provided for controlling a laser source that includes two laser discharge chambers. An example laser control system can include a first pulsed powertrain including a first independent circuit configured to generate a first resonant charging supply (RCS) output voltage. The first RCS output voltage can be configured to drive a first laser discharge chamber. The example laser control system can further include a second pulsed powertrain including a second independent circuit configured to generate a second RCS output voltage independent from the first RCS output voltage. The second RCS output voltage can be configured to drive a second laser discharge chamber independent from the first laser discharge chamber.

### CROSS REFERENCE TO RELATED APPLICATIONS

This application claims priority to U.S. Application No. 62/955,620 filed Dec. 31, 2019 and titled DUAL PULSED POWER SYSTEM WITH INDEPENDENT VOLTAGE AND TIMING CONTROL AND REDUCED POWER CONSUMPTION, which is incorporated herein in its entirety by reference.

### FIELD

The present disclosure relates to systems and methods for controlling a laser source for use in, for example, lithographic apparatuses and systems.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is interchangeably referred to as a mask or a reticle, can be used to generate a circuit pattern to be formed on an individual layer of the IC being formed. This pattern can be transferred onto a target portion (e.g., including part of, one, or several dies) on a substrate (e.g., a silicon wafer). Transfer of the pattern is typically via imaging onto a layer of radiation-sensitive material (e.g., resist) provided on the substrate. In general, a single substrate will contain a network of adjacent target portions that are successively patterned. Traditional lithographic apparatuses include so-called steppers, in which each target portion is irradiated by exposing an entire pattern onto the target portion at one time, and so-called scanners, in which each target portion is irradiated by scanning the pattern through a radiation beam in a given direction (the scanning direction) while synchronously scanning the target portions parallel or anti-parallel to this scanning direction. It is also possible to transfer the pattern from the patterning device to the substrate by imprinting the pattern onto the substrate.

A laser source can be used with a lithographic apparatus to generate radiation for illuminating the patterning device. The laser source can include dual pulsed powertrains to drive two separate laser discharge chambers used to generate and amplify a laser beam for use in the lithographic apparatus. There is a need for a system and a method for controlling the laser source and its dual powertrains.

### SUMMARY

The present disclosure describes various aspects of systems, apparatuses, methods, and computer program products for controlling a laser source and its powertrains, such as a dual pulsed power system with independent voltage and timing control and, in some instances, reduced power consumption. In some aspects, the present disclosure provides for independent voltage control for each powertrain. In some aspects, the present disclosure provides for independent control of each pulsed powertrain to allow for three modes of operation: (i) single pulsed powertrain operation; (ii) synchronized dual output with independent voltage operation; or (iii) interleaved dual output with independent voltage operation. In some aspects, the present disclosure provides for single channel operation to allow for “soft-landing” or “limp along” capability or ability to service one powertrain while the other powertrain is still in operation. In some aspects, the present disclosure provides for single channel operation to allow for reduced power consumption and reduced lifetime reduction.

In some aspects, the present disclosure describes a laser control system. The laser control system can include a first pulsed powertrain including a first independent circuit configured to generate a first resonant charging supply (RCS) output voltage. The first RCS output voltage can be configured to drive a first laser discharge chamber. The laser control system can further include a second pulsed powertrain including a second independent circuit configured to generate a second RCS output voltage independent from the first RCS output voltage. The second RCS output voltage can be configured to drive a second laser discharge chamber independent from the first laser discharge chamber.

In some aspects, the present disclosure describes an apparatus. The apparatus can include a first pulsed powertrain including a first independent circuit configured to generate a first RCS output voltage. The first RCS output voltage can be configured to drive a first laser discharge chamber. The apparatus can further include a second pulsed powertrain including a second independent circuit configured to generate a second RCS output voltage independent from the first RCS output voltage. The second RCS output voltage can be configured to drive a second laser discharge chamber independent from the first laser discharge chamber.

In some aspects, the present disclosure describes a method for manufacturing an apparatus. The method can include providing a first pulsed powertrain including a first independent circuit configured to generate a first RCS output voltage. The first RCS output voltage can be configured to drive a first laser discharge chamber. The method can further include providing a second pulsed powertrain including a second independent circuit configured to generate a second RCS output voltage independent from the first RCS output voltage. The second RCS output voltage can be configured to drive a second laser discharge chamber independent from the first laser discharge chamber. The method can further include forming a laser control system including the first pulsed powertrain and the second pulsed powertrain.

Further features, as well as the structure and operation of various aspects, are described in detail below with reference to the accompanying drawings. It is noted that the disclosure is not limited to the specific aspects described herein. Such aspects are presented herein for illustrative purposes only. Additional aspects will be apparent to persons skilled in the relevant art(s) based on the teachings contained herein.

### BRIEF DESCRIPTION OF THE DRAWINGS

The accompanying drawings, which are incorporated herein and form part of the specification, illustrate the present disclosure and, together with the description, further serve to explain the principles of the aspects of this disclosure and to enable a person skilled in the relevant art(s) to make and use the aspects of this disclosure.

FIG. 1A is a schematic illustration of an example reflective lithographic apparatus according to some aspects of the present disclosure.

FIG. 1B is a schematic illustration of an example transmissive lithographic apparatus according to some aspects of the present disclosure.

FIG. 2 is a more detailed schematic illustration of the reflective lithographic apparatus shown in FIG. 1A according to some aspects of the present disclosure.

FIG. 3 is a schematic illustration of an example lithographic cell according to some aspects of the present disclosure.

FIG. 4 is a schematic illustration of an example laser source that includes an example laser control system according to some aspects of the present disclosure.

FIG. 5 is a schematic illustration of another example laser source that includes another example laser control system according to some aspects of the present disclosure.

FIG. 6 is a schematic illustration of yet another example laser source that includes yet another example laser control system according to some aspects of the present disclosure.

FIG. 7 is a flow chart illustrating an example of a method for manufacturing an apparatus according to some aspects of the present disclosure or portion(s) thereof.

FIG. 8 is an example computer system for implementing some aspects of the present disclosure or portion(s) thereof.

The features and advantages of the present disclosure will become more apparent from the detailed description set forth below when taken in conjunction with the drawings, in which like reference characters identify corresponding elements throughout. In the drawings, unless otherwise indicated, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

This specification discloses one or more embodiments that incorporate the features of the present disclosure. The disclosed embodiment(s) merely describe the present disclosure. The scope of the disclosure is not limited to the disclosed embodiment(s). The breadth and scope of the disclosure are defined by the claims appended hereto and their equivalents.

The embodiment(s) described, and references in the specification to “one embodiment,” “an embodiment,” “an example embodiment,” etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to affect such feature, structure, or characteristic in connection with other embodiments whether or not explicitly described.

Spatially relative terms, such as “beneath,” “below,” “lower,” “above,” “on,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus can be otherwise oriented (rotated 90 degrees or at other orientations) and the spatially relative descriptors used herein may likewise be interpreted accordingly.

The term “about” as used herein indicates the value of a given quantity that can vary based on a particular technology. Based on the particular technology, the term “about” can indicate a value of a given quantity that varies within, for example, 10-30% of the value (e.g., ±10%, ±20%, or ±30% of the value).

### Overview

Conventional pulsed power systems in deep ultra violet (DUV) lithographic apparatuses have dual powertrains to drive the laser discharge chambers. By design, each pulsed powertrain typically is controlled to the same operating voltage and triggered synchronously to allow for master oscillator power amplifier (MOPA) and master oscillator power ring amplifier (MOPRA) laser operation.

A pulsed power system can include a high voltage power supply, a resonant charging supply, a master oscillator (MO) commutator, an MO compression head, a power amplifier (PA) or power ring amplifier (PRA) commutator, a PA or PRA compression head, an MO laser discharge chamber, and a PA or PRA laser discharge chamber. Ancillary components can include: a laser control system configured to provide voltage and timing control to the pulsed power system; and an input stage sub-rack and power distribution system configured to manage the alternating current (AC) and direct current (DC) power to the pulsed power system.

In addition, a pulsed power system can include a blower system for each laser discharge chamber that is driven by a master/slave blower motor controller. In normal operation, both of these blower systems are energized and operate at the target blower speed. The blower system can include: an MO blower motor controller (BMC), which includes both a master and slave output; an MO master blower motor; an MO slave blower motor; a PA or PRA master blower motor; and a PA or PRA slave blower motor. A pulsed power system can also include heater and cooling sub-systems for each laser discharge chamber that are utilized to help maintain an optimal chamber temperature during operation and idle states.

Driving the MO and PA or PRA laser discharge chambers at the same voltage can be beneficial in timing control and synchronization, butt his can have several drawbacks. For example, the MO and PA or PRA laser discharge chambers are designed to operate for their specific application (e.g., as a master oscillator, power amplifier, or power ring amplifier, respectively). The operating conditions for each application can benefit from being able to independently control the voltages and associated timing of each laser discharge chamber's pulse power system. However, conventional timing control systems only allow for independent timing control of the dual chamber system. Decoupling the voltage control for each laser discharge chamber's pulsed power system can provide benefits to the performance, reliability, and lifetime of systems, sub-systems, and components included therein or associated therewith. Decoupled voltage control can also benefit laser source designs that require single channel operation, interleaved firing, synchronized firing, and/or simultaneous firing.

Current pulsed power systems require the charging and discharging of each pulsed powertrain and close timing differences (e.g., less than about 5.0 nanoseconds). As a result, neither single channel operation nor interleaved operation is an option for current pulsed power systems. In addition, current pulsed power systems do not allow for the independent operation or service of one pulsed powertrain while the other pulsed powertrain is energized or in operation. Further, current pulsed power systems do not allow for soft-landing if one pulsed powertrain fails but the other pulsed powertrain is still operable. Further still, during dual chamber discharge operation, current pulsed power systems require the blower system for each laser discharge chamber to be in operation to support MOPA or MOPRA operation. Typically, the blower system is energized and commanded to operate at the same time. The chamber temperature control sub-system is also operated independently but at the same time. Similarly, during single chamber operation, current pulsed power systems consume power to operate the idle chamber, which drives: increased power consumption; increased cooling operation (e.g., air cooling, water cooling); increased heating operation; increased operating costs; reduced system, sub-system, and component lifetime; and reduced system, sub-system, and component reliability.

In contrast to these conventional systems, the present disclosure provides methods for independently controlling the voltage of each laser discharge chamber in a dual chamber laser source. In some aspects described herein, the present disclosure provides for controlling a laser source that includes dual pulsed powertrains. In some aspects described herein, the present disclosure provides for a dual pulsed power system with independent voltage and timing control and, in some instances, reduced power consumption.

In some aspects described herein, an example laser control system can include a first pulsed powertrain including a first independent circuit (e.g., a first independent charging and voltage regulation circuit) configured to generate a first resonant charging supply (RCS) output voltage. The first RCS output voltage can be configured to drive a first laser discharge chamber. The example laser control system can further include a second pulsed powertrain including a second independent circuit (e.g., a second independent charging and voltage regulation circuit) configured to generate a second RCS output voltage independent from the first RCS output voltage. The second RCS output voltage can be configured to drive a second laser discharge chamber independent from the first laser discharge chamber.

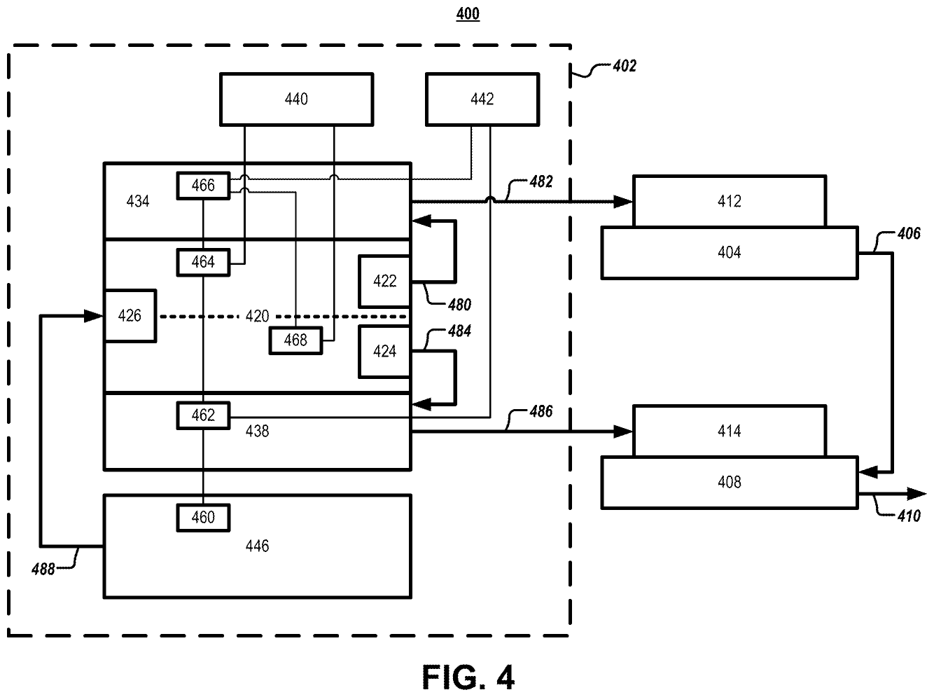

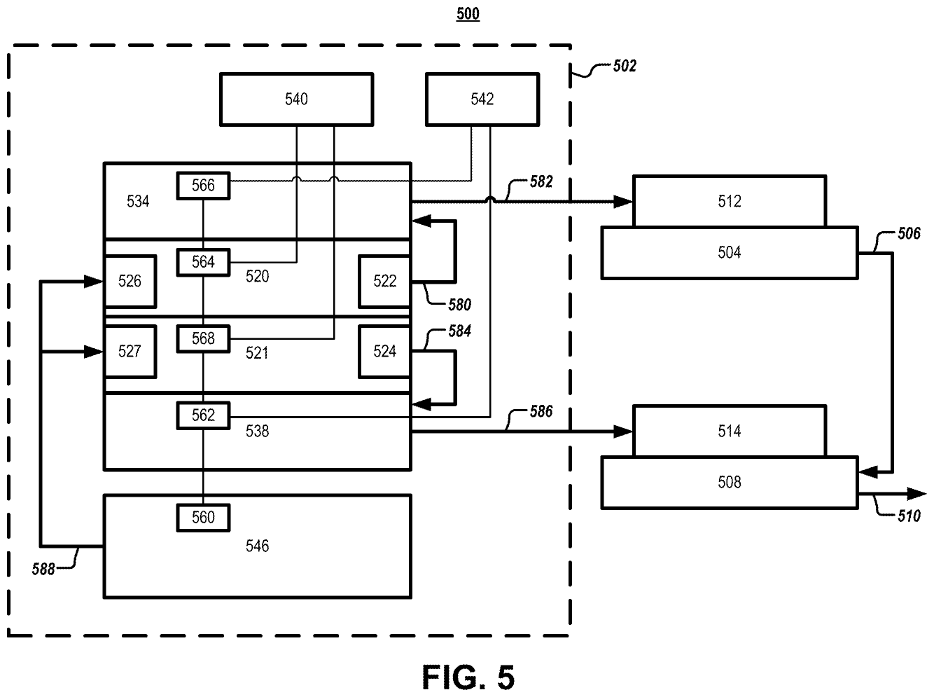

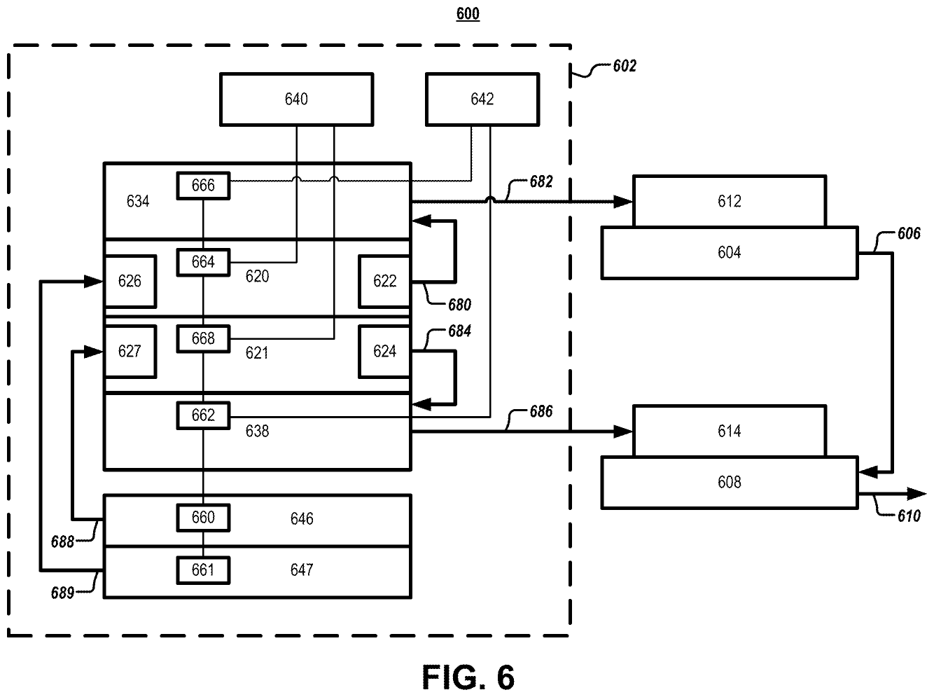

In some aspects, independent voltage control of the two pulsed power drivetrains could be implemented by changing the RCS design such that each RCS output is coupled to an independent charging and voltage regulation circuit. Each resonant charging circuit can either: (i) share a reservoir capacitor (e.g., the example laser control system 402 shown in FIG. 4); or (ii) have separate reservoir capacitors (e.g., the example laser control system 502 shown in FIG. 5; the example laser control system 602 shown in FIG. 6). Further, each reservoir capacitor can be charged by either: (iii) a common high voltage power supply (HVPS) (e.g., the example laser control system 402 shown in FIG. 4; the example laser control system 502 shown in FIG. 5); or (iv) its own HVPS (e.g., one HVPS for each reservoir capacitor, such as in the example laser control system 602 shown in FIG. 6). For example, the present disclosure provides for a laser control system (e.g., an independent voltage pulsed power system) having dual independent charging and voltage regulation circuits together with either: (a) a single RCS, a single reservoir capacitor, and a single HVPS (e.g., the example laser control system 402 shown in FIG. 4); (b) dual RCSs, dual reservoir capacitors, and a single HVPS (e.g., the example laser control system 502 shown in FIG. 5); or (c) dual RCSs, dual reservoir capacitors, and dual HVPSs (e.g., the example laser control system 602 shown in FIG. 6).

In some aspects, decoupling the pulse power system farther upstream from the laser discharge chambers increases the potential benefit in being able to independently operate and service the pulsed powertrains. In some aspects, decoupling the resonant charging circuits for the two pulsed powertrains will allow for independent energy recovery of each pulsed powertrain. In some aspects, the requirement for closely synchronizing the discharge of the two pulsed powertrains can be eliminated and allow for single channel operation, stutter operation, or interleaved operation, as well as continued use of MOPA or MOPRA operation.

In some aspects, to address potential timing synchronization for MOPA or MOPRA operation, the pulsed power system disclosed herein can provide for tight timing control and jitter for each pulsed powertrain to allow for +/−2.0 nanoseconds of timing jitter. The timing jitter budget depends on several components in the pulsed powertrain, such as: the resonant charger voltage repeatability; the variation in timing of the switching and pulse compression circuits in the commutator and compression head; and variations in timing due to the discharging of the laser discharge chambers. In some aspects, the RCS voltage repeatability can be improved if independent voltage operation is needed for the MOPA or MOPRA operation. For example, timing variation as a function of voltage can be about 2.0 nanoseconds/volt, which will drive a voltage repeatability in the resonant charge to be less than about 0.1 percent (+/−0.05 percent) or ideally below 0.05 percent (+/−0.025 percent). In some aspects, RCS common-mode repeatability can be limited to +/−0.1 percent using voltage regulation circuitry. In some aspects, further improvement in the voltage repeatability can be achieved by implementing additional fine regulation circuitry to allow for improved voltage repeatability. In an illustrative example, one such realization can be the use of a bleed down circuit that is used after the voltage regulation circuit has completed.

In some aspects, decoupling the blower systems for the two laser discharge chambers can provide for independent operation for each laser discharge chamber. In dual chamber operation, the blower systems can continue to be energized and controlled to operate at the same time. In single chamber operation, one blower system can be idled to reduce or eliminate the power consumption that is normally used in dual chamber operation.

In some aspects, decoupling the temperature control systems for the two laser discharge chambers can provide for independent operation for each laser discharge chamber. In dual chamber operation, the temperature control systems can continue to be energized and controlled to operate at the same time. In single chamber operation, one temperature control system can be idled to reduce or eliminate the power consumption and actuations that is normally used in dual chamber operation.

In some aspects, the laser source disclosed herein can utilize two independent lasers rather than a single laser.

There are many advantages and benefits to the systems, apparatuses methods, computer program produces, and manufacturing techniques disclosed herein. For example, the present disclosure provides for independent voltage control for each powertrain. Further, the present disclosure provides for independent control of each pulsed powertrain to allow for three modes of operation: (i) single pulsed powertrain operation; (ii) synchronized dual output with independent voltage operation; or (iii) interleaved dual output with independent voltage operation. Further still, the present disclosure provides for single channel operation to allow for “soft-landing” or “limp along” capability or ability to service one powertrain while the other powertrain is still in operation. In addition, the present disclosure provides for single channel operation to allow for reduced power consumption and reduced lifetime reduction. As a result, these and other aspects of the present disclosure provide for: reduced cost of operation; reduced planned and unplanned downtime; and improved serviceability through lighter weight system. Additionally, during single chamber operation as well as other modes of operation, these and other aspects of the present disclosure provide for: reduced power consumption; reduced cooling operation (e.g., air cooling, water cooling); reduced heating operation; reduced operating costs; increased system, sub-system, and component lifetime; and increased system, sub-system, and component reliability.

Before describing such aspects in more detail, however, it is instructive to present an example environment in which aspects of the present disclosure can be implemented.

### Example Lithographic Systems

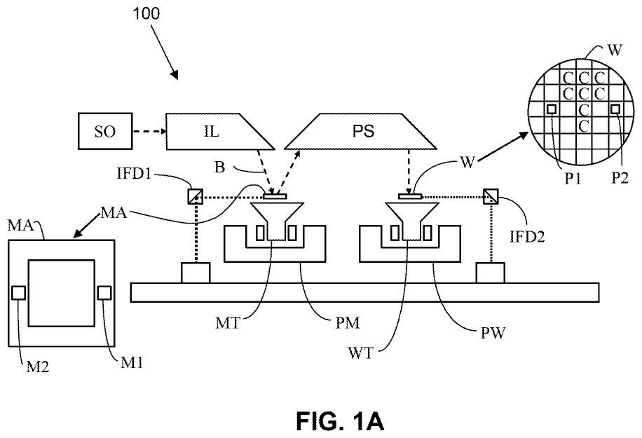

FIGS. 1A and 1B are schematic illustrations of a lithographic apparatus 100 and lithographic apparatus 100′, respectively, in which aspects of the present disclosure can be implemented. As shown in FIGS. 1A and 1B, the lithographic apparatuses 100 and 100′ are illustrated from a point of view (e.g., a side view) that is normal to the XZ plane (e.g., the X-axis points to the right and the Z-axis points upward), while the patterning device MA and the substrate W are presented from additional points of view (e.g., a top view) that are normal to the XY plane (e.g., the X-axis points to the right and the Y-axis points upward).

Lithographic apparatus 100 and lithographic apparatus 100′ each include the following: an illumination system IL (e.g., an illuminator) configured to condition a radiation beam B (e.g., a deep ultra violet (DUV) radiation beam or an extreme ultra violet (EUV) radiation beam); a support structure MT (e.g., a mask table) configured to support a patterning device MA (e.g., a mask, a reticle, or a dynamic patterning device) and connected to a first positioner PM configured to accurately position the patterning device MA; and, a substrate holder such as a substrate table WT (e.g., a wafer table) configured to hold a substrate W (e.g., a resist-coated wafer) and connected to a second positioner PW configured to accurately position the substrate W. Lithographic apparatuses 100 and 100′ also have a projection system PS configured to project a pattern imparted to the radiation beam B by patterning device MA onto a target portion C (e.g., a portion including one or more dies) of the substrate W. In lithographic apparatus 100, the patterning device MA and the projection system PS are reflective. In lithographic apparatus 100′, the patterning device MA and the projection system PS are transmissive.

The illumination system IL can include various types of optical components, such as refractive, reflective, catadioptric, magnetic, electromagnetic, electrostatic, or other types of optical components, or any combination thereof, for directing, shaping, or controlling the radiation beam B.

The support structure MT holds the patterning device MA in a manner that depends on the orientation of the patterning device MA with respect to a reference frame, the design of at least one of the lithographic apparatuses 100 and 100′, and other conditions, such as whether or not the patterning device MA is held in a vacuum environment. The support structure MT can use mechanical, vacuum, electrostatic, or other clamping techniques to hold the patterning device MA. The support structure MT can be a frame or a table, for example, which can be fixed or movable, as required. By using sensors, the support structure MT can ensure that the patterning device MA is at a desired position, for example, with respect to the projection system PS.

The term “patterning device” MA should be broadly interpreted as referring to any device that can be used to impart a radiation beam B with a pattern in its cross-section, such as to create a pattern in the target portion C of the substrate W. The pattern imparted to the radiation beam B can correspond to a particular functional layer in a device being created in the target portion C to form an integrated circuit.

The patterning device MA can be transmissive (as in lithographic apparatus 100′ of FIG. 1B) or reflective (as in lithographic apparatus 100 of FIG. 1A). Examples of patterning devices MA include reticles, masks, programmable mirror arrays, or programmable LCD panels. Masks include mask types such as binary, alternating phase shift, or attenuated phase shift, as well as various hybrid mask types. An example of a programmable mirror array employs a matrix arrangement of small mirrors, each of which can be individually tilted so as to reflect an incoming radiation beam in different directions. The tilted mirrors impart a pattern in the radiation beam B, which is reflected by a matrix of small mirrors.

The term “projection system” PS can encompass any type of projection system, including refractive, reflective, catadioptric, magnetic, electromagnetic and electrostatic optical systems, or any combination thereof, as appropriate for the exposure radiation being used, or for other factors, such as the use of an immersion liquid on the substrate W or the use of a vacuum. A vacuum environment can be used for EUV or electron beam radiation since other gases can absorb too much radiation or electrons. A vacuum environment can therefore be provided to the whole beam path with the aid of a vacuum wall and vacuum pumps.

Lithographic apparatus 100 and/or lithographic apparatus 100′ can be of a type having two (dual stage) or more substrate tables WT (and/or two or more mask tables). In such “multiple stage” machines, the additional substrate tables WT can be used in parallel, or preparatory steps can be carried out on one or more tables while one or more other substrate tables WT are being used for exposure. In some situations, the additional table may not be a substrate table WT.

The lithographic apparatus can also be of a type wherein at least a portion of the substrate can be covered by a liquid having a relatively high refractive index, e.g., water, so as to fill a space between the projection system and the substrate. An immersion liquid can also be applied to other spaces in the lithographic apparatus, for example, between the mask and the projection system Immersion techniques provide for increasing the numerical aperture of projection systems. The term “immersion” as used herein does not mean that a structure, such as a substrate, must be submerged in liquid, but rather only means that liquid is located between the projection system and the substrate during exposure.

Referring to FIGS. 1A and 1B, the illumination system IL receives a radiation beam B from a radiation source SO. The radiation source SO and the lithographic apparatus 100 or 100′ can be separate physical entities, for example, when the radiation source SO is an excimer laser. In such cases, the radiation source SO is not considered to form part of the lithographic apparatus 100 or 100′, and the radiation beam B passes from the radiation source SO to the illumination system IL with the aid of a beam delivery system BD (e.g., shown in FIG. 1B) including, for example, suitable directing mirrors and/or a beam expander. In other cases, the radiation source SO can be an integral part of the lithographic apparatus 100 or 100′, for example, when the radiation source SO is a mercury lamp. The radiation source SO and the illuminator IL, together with the beam delivery system BD, if required, can be referred to as a radiation system.

The illumination system IL can include an adjuster AD (e.g., shown in FIG. 1B) for adjusting the angular intensity distribution of the radiation beam. Generally, at least the outer and/or inner radial extent (commonly referred to as “σ-outer” and “σ-inner,” respectively) of the intensity distribution in a pupil plane of the illuminator can be adjusted. In addition, the illumination system IL can include various other components (e.g., shown in FIG. 1B), such as an integrator IN and a radiation collector CO (e.g., a condenser or collector optic). The illumination system IL can be used to condition the radiation beam B to have a desired uniformity and intensity distribution in its cross section.

Referring to FIG. 1A, the radiation beam B is incident on the patterning device MA (e.g., a mask), which is held on the support structure MT (e.g., a mask table), and is patterned by the patterning device MA. In lithographic apparatus 100, the radiation beam B is reflected from the patterning device MA. After being reflected from the patterning device MA, the radiation beam B passes through the projection system PS, which focuses the radiation beam B onto a target portion C of the substrate W. With the aid of the second positioner PW and position sensor IFD2 (e.g., an interferometric device, linear encoder, or capacitive sensor), the substrate table WT can be moved accurately (e.g., so as to position different target portions C in the path of the radiation beam B). Similarly, the first positioner PM and another position sensor IFD1 (e.g., an interferometric device, linear encoder, or capacitive sensor) can be used to accurately position the patterning device MA with respect to the path of the radiation beam B. Patterning device MA and substrate W can be aligned using mask alignment marks M1 and M2 and substrate alignment marks P1 and P2.

Referring to FIG. 1B, the radiation beam B is incident on the patterning device MA, which is held on the support structure MT, and is patterned by the patterning device MA. Having traversed the patterning device MA, the radiation beam B passes through the projection system PS, which focuses the beam onto a target portion C of the substrate W. The projection system has a pupil conjugate PPU to an illumination system pupil IPU. Portions of radiation emanate from the intensity distribution at the illumination system pupil IPU and traverse a mask pattern without being affected by diffraction at the mask pattern and create an image of the intensity distribution at the illumination system pupil IPU.

The projection system PS projects an image MP′ of the mask pattern MP, where image MP′ is formed by diffracted beams produced from the mask pattern MP by radiation from the intensity distribution, onto a resist layer coated on the substrate W. For example, the mask pattern MP can include an array of lines and spaces. A diffraction of radiation at the array and different from zeroth-order diffraction generates diverted diffracted beams with a change of direction in a direction perpendicular to the lines. Undiffracted beams (e.g., so-called zeroth-order diffracted beams) traverse the pattern without any change in propagation direction. The zeroth-order diffracted beams traverse an upper lens or upper lens group of the projection system PS, upstream of the pupil conjugate PPU of the projection system PS, to reach the pupil conjugate PPU. The portion of the intensity distribution in the plane of the pupil conjugate PPU and associated with the zeroth-order diffracted beams is an image of the intensity distribution in the illumination system pupil IPU of the illumination system IL. The aperture device PD, for example, is disposed at or substantially at a plane that includes the pupil conjugate PPU of the projection system PS.

The projection system PS is arranged to capture, by means of a lens or lens group L, not only the zeroth-order diffracted beams, but also first-order or first- and higher-order diffracted beams (not shown). In some aspects, dipole illumination for imaging line patterns extending in a direction perpendicular to a line can be used to utilize the resolution enhancement effect of dipole illumination. For example, first-order diffracted beams interfere with corresponding zeroth-order diffracted beams at the level of the substrate W to create an image of the mask pattern MP at highest possible resolution and process window (e.g., usable depth of focus in combination with tolerable exposure dose deviations). In some aspects, astigmatism aberration can be reduced by providing radiation poles (not shown) in opposite quadrants of the illumination system pupil IPU. Further, in some aspects, astigmatism aberration can be reduced by blocking the zeroth-order beams in the pupil conjugate PPU of the projection system associated with radiation poles in opposite quadrants.

With the aid of the second positioner PW and position sensor IFD (e.g., an interferometric device, linear encoder, or capacitive sensor), the substrate table WT can be moved accurately (e.g., so as to position different target portions C in the path of the radiation beam B). Similarly, the first positioner PM and another position sensor (not shown in FIG. 1B) can be used to accurately position the patterning device MA with respect to the path of the radiation beam B (e.g., after mechanical retrieval from a mask library or during a scan).

In general, movement of the support structure MT can be realized with the aid of a long-stroke positioner (coarse positioning) and a short-stroke positioner (fine positioning), which form part of the first positioner PM. Similarly, movement of the substrate table WT can be realized using a long-stroke positioner and a short-stroke positioner, which form part of the second positioner PW. In the case of a stepper (as opposed to a scanner), the support structure MT can be connected to a short-stroke actuator only or can be fixed. Patterning device MA and substrate W can be aligned using mask alignment marks M1, M2, and substrate alignment marks P1, P2. Although the substrate alignment marks (as illustrated) occupy dedicated target portions, they can be located in spaces between target portions (e.g., scribe-lane alignment marks). Similarly, in situations in which more than one die is provided on the patterning device MA, the mask alignment marks can be located between the dies.

Support structure MT and patterning device MA can be in a vacuum chamber V, where an in-vacuum robot IVR can be used to move patterning devices such as a mask in and out of vacuum chamber. Alternatively, when support structure MT and patterning device MA are outside of the vacuum chamber, an out-of-vacuum robot can be used for various transportation operations, similar to the in-vacuum robot IVR. In some instances, both the in-vacuum and out-of-vacuum robots need to be calibrated for a smooth transfer of any payload (e.g., a mask) to a fixed kinematic mount of a transfer station.

The lithographic apparatuses 100 and 100′ can be used in at least one of the following modes:

1. In step mode, the support structure MT and the substrate table WT are kept essentially stationary, while an entire pattern imparted to the radiation beam B is projected onto a target portion C at one time (e.g., a single static exposure). The substrate table WT is then shifted in the X and/or Y direction so that a different target portion C can be exposed.

2. In scan mode, the support structure MT and the substrate table WT are scanned synchronously while a pattern imparted to the radiation beam B is projected onto a target portion C (e.g., a single dynamic exposure). The velocity and direction of the substrate table WT relative to the support structure MT (e.g., mask table) can be determined by the (de-) magnification and image reversal characteristics of the projection system PS.

3. In another mode, the support structure MT is kept substantially stationary holding a programmable patterning device MA, and the substrate table WT is moved or scanned while a pattern imparted to the radiation beam B is projected onto a target portion C. A pulsed radiation source SO can be employed and the programmable patterning device is updated as required after each movement of the substrate table WT or in between successive radiation pulses during a scan. This mode of operation can be readily applied to maskless lithography that utilizes a programmable patterning device MA, such as a programmable mirror array.

Combinations and/or variations on the described modes of use or entirely different modes of use can also be employed.

In a further aspect, lithographic apparatus 100 includes an EUV source, which is configured to generate a beam of EUV radiation for EUV lithography. In general, the EUV source is configured in a radiation system, and a corresponding illumination system is configured to condition the EUV radiation beam of the EUV source.

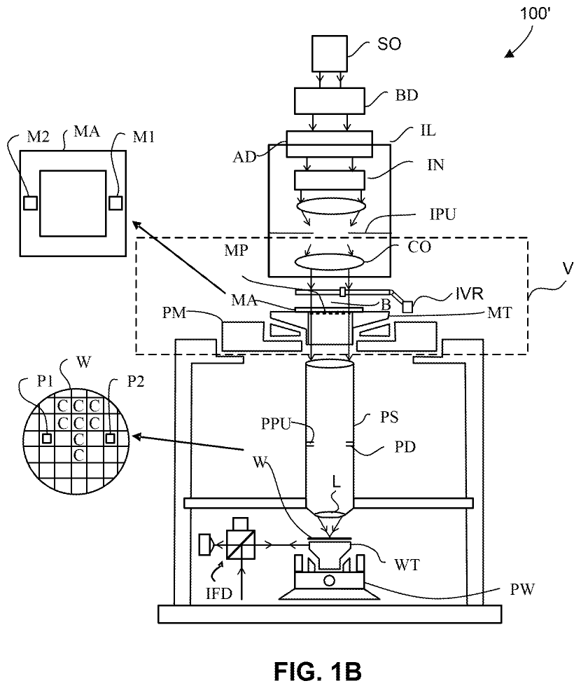

FIG. 2 shows the lithographic apparatus 100 in more detail, including the radiation source SO (e.g., a source collector apparatus), the illumination system IL, and the projection system PS. As shown in FIG. 2, the lithographic apparatus 100 is illustrated from a point of view (e.g., a side view) that is normal to the XZ plane (e.g., the X-axis points to the right and the Z-axis points upward).

The radiation source SO is constructed and arranged such that a vacuum environment can be maintained in an enclosing structure 220. The radiation source SO includes a source chamber 211 and a collector chamber 212 and is configured to produce and transmit EUV radiation. EUV radiation can be produced by a gas or vapor, for example xenon (Xe) gas, lithium (Li) vapor, or tin (Sn) vapor in which an EUV radiation emitting plasma 210 is created to emit radiation in the EUV range of the electromagnetic spectrum. The EUV radiation emitting plasma 210, at least partially ionized, can be created by, for example, an electrical discharge or a laser beam. Partial pressures of, for example, about 10.0 pascals (Pa) of Xe gas, Li vapor, Sn vapor, or any other suitable gas or vapor can be used for efficient generation of the radiation. In some aspects, a plasma of excited tin is provided to produce EUV radiation.

The radiation emitted by the EUV radiation emitting plasma 210 is passed from the source chamber 211 into the collector chamber 212 via an optional gas barrier or contaminant trap 230 (e.g., in some cases also referred to as contaminant barrier or foil trap), which is positioned in or behind an opening in source chamber 211. The contaminant trap 230 can include a channel structure. Contamination trap 230 can also include a gas barrier or a combination of a gas barrier and a channel structure. The contaminant trap 230 further indicated herein at least includes a channel structure.

The collector chamber 212 can include a radiation collector CO (e.g., a condenser or collector optic), which can be a so-called grazing incidence collector. Radiation collector CO has an upstream radiation collector side 251 and a downstream radiation collector side 252. Radiation that traverses radiation collector CO can be reflected off a grating spectral filter 240 to be focused in a virtual source point IF. The virtual source point IF is commonly referred to as the intermediate focus, and the source collector apparatus is arranged such that the virtual source point IF is located at or near an opening 219 in the enclosing structure 220. The virtual source point IF is an image of the EUV radiation emitting plasma 210. Grating spectral filter 240 is used in particular for suppressing infrared (IR) radiation.

Subsequently the radiation traverses the illumination system IL, which can include a faceted field mirror device 222 and a faceted pupil mirror device 224 arranged to provide a desired angular distribution of the radiation beam 221, at the patterning device MA, as well as a desired uniformity of radiation intensity at the patterning device MA. Upon reflection of the radiation beam 221 at the patterning device MA, held by the support structure MT, a patterned beam 226 is formed and the patterned beam 226 is imaged by the projection system PS via reflective elements 228, 229 onto a substrate W held by the wafer stage or substrate table WT.

More elements than shown can generally be present in illumination system IL and projection system PS. Optionally, the grating spectral filter 240 can be present depending upon the type of lithographic apparatus. Further, there can be more mirrors present than those shown in the FIG. 2. For example, there can be one to six additional reflective elements present in the projection system PS than shown in FIG. 2.

Radiation collector CO, as illustrated in FIG. 2, is depicted as a nested collector with grazing incidence reflectors 253, 254, and 255, just as an example of a collector (or collector mirror). The grazing incidence reflectors 253, 254, and 255 are disposed axially symmetric around an optical axis O and a radiation collector CO of this type is preferably used in combination with a discharge produced plasma (DPP) source.

### Example Lithographic Cell

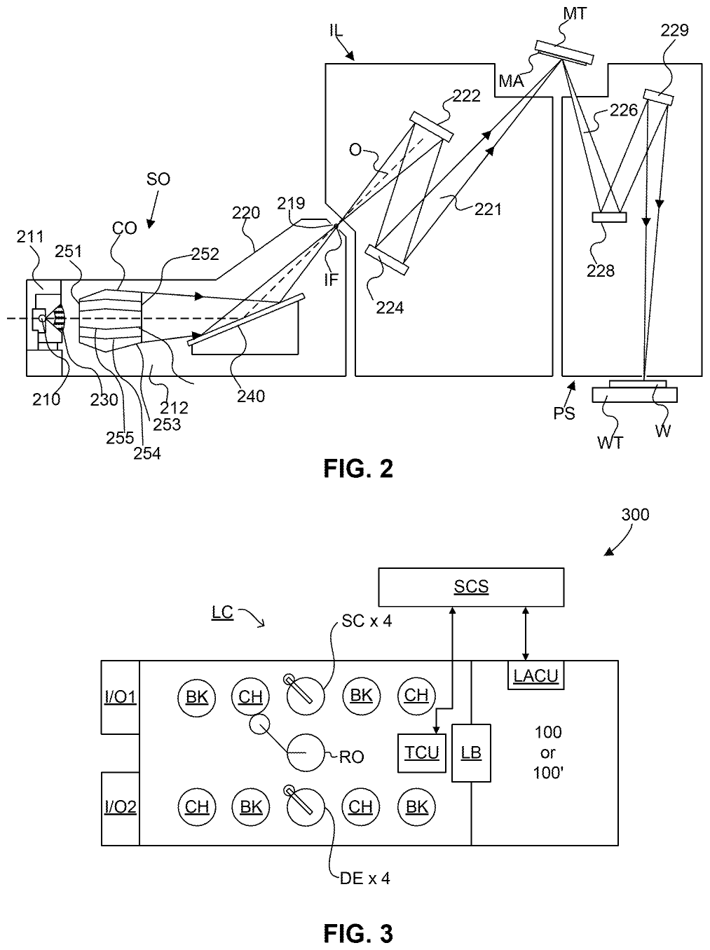

FIG. 3 shows a lithographic cell 300, also sometimes referred to a lithocell or cluster. As shown in FIG. 3, the lithographic cell 300 is illustrated from a point of view (e.g., a top view) that is normal to the XY plane (e.g., the X-axis points to the right and the Y-axis points upward).

Lithographic apparatus 100 or 100′ can form part of lithographic cell 300. Lithographic cell 300 can also include one or more apparatuses to perform pre- and post-exposure processes on a substrate. For example, these apparatuses can include spin coaters SC to deposit resist layers, developers DE to develop exposed resist, chill plates CH, and bake plates BK. A substrate handler RO (e.g., a robot) picks up substrates from input/output ports I/O1 and I/O2, moves them between the different process apparatuses and delivers them to the loading bay LB of the lithographic apparatus 100 or 100′. These devices, which are often collectively referred to as the track, are under the control of a track control unit TCU, which is itself controlled by a supervisory control system SCS, which also controls the lithographic apparatus via lithography control unit LACU. Thus, the different apparatuses can be operated to maximize throughput and processing efficiency.

### Example Laser Sources Including Example Laser Control Systems

### Example Laser Control System Having a Single RCS, a Single Reservoir Capacitor, and a Single HVPS

FIG. 4 is a schematic illustration of an example laser source 400 that includes an example laser control system 402 (e.g., an independent voltage pulsed power system) according to some aspects of the present disclosure. In some aspects, the example laser control system 402 can include dual independent charging and voltage regulation circuits (e.g., first independent circuit 422 and second independent circuit 424) together with a single RCS (e.g., common RCS 420), a single reservoir capacitor (e.g., common reservoir capacitor 426), and a single HVPS (e.g., common HVPS 446). In some aspects, the example laser source 400 can be used as part of, or in addition to, radiation source SO of lithographic apparatus 100 or 100′. Additionally, or alternatively, the example laser source 400 can generate DUV radiation to be used in DUV lithography.

As illustrated in FIG. 4, the example laser source 400 can be a dual chamber laser source that includes a dual pulsed power system with independent voltage and timing control and, in some instances, reduced power consumption. For example, the example laser source 400 can include a first laser discharge chamber 404 configured to generate a first laser beam 406 and a second laser discharge chamber 408 configured to receive the first laser beam 406 and amplify the first laser beam 406 to generate a second laser beam 410. The example laser source 400 can output the second laser beam 410, or a modified version thereof, to a lithographic apparatus (e.g., lithographic apparatus 100 or 110′). Although some aspects discussed with reference to the example laser source 400 include two laser discharge chambers, the aspects of this disclosure can be applied to laser sources that include a single laser discharge chamber or multiple laser discharge chambers.

In some aspects, the second laser discharge chamber 408 can be configured to receive and amplify light from the first laser discharge chamber 404. In some aspects, the first laser discharge chamber 404 can be implemented as part of a master oscillator (MO), and the second laser discharge chamber 408 can be implemented as part of a power amplifier (PA) or a power ring amplifier (PRA). For example, the example laser source 400 can be a MOPA laser source that includes a MO and a PA, where the MO includes the first laser discharge chamber 404 and the PA includes the second laser discharge chamber 408. In another example, the example laser source 400 can be a MOPRA laser source that includes a MO and a PRA, where the MO includes the first laser discharge chamber 404 and the PRA includes the second laser discharge chamber 408.

In some aspects, the example laser source 400 can include one or more compression heads. For example, the example laser source 400 can include a first compression head 412 coupled to the first laser discharge chamber 404, and the example laser source 400 can further include a second compression head 414 coupled to the second laser discharge chamber 408.

In some aspects, the first laser discharge chamber 404 and the second laser discharge chamber 408 can contain a mixture of gases. For example, in aspects where the example laser source 400 is an excimer laser source, the first laser discharge chamber 404 and the second laser discharge chamber 408 can contain a halogen (e.g., fluorine) along with other gases (e.g., argon, neon, and other suitable gases) used in producing and amplifying laser beams. In some aspects, the first laser discharge chamber 404 and the second laser discharge chamber 408 can include the same mixture of gases or different mixtures of gases. For example, the first laser discharge chamber 404 and the second laser discharge chamber 408 can both include a krypton gas.

In some aspects, the example laser source 400 can include, or can be coupled to, one or more gas sources (e.g., gas bottles) and one or more gas control systems configured to control independently the one or more gas sources. For example, a first gas source can be coupled to first laser discharge chamber 404 to provide a first gas mixture used for generating the first laser beam 406. Additionally, a second gas source can be coupled to second laser discharge chamber 408 to provide a second gas mixture used for generating second laser beam 410. In some aspects, the second gas source can be substantially similar to the first gas source, and the second gas mixture can be identical, or nearly identical, to the first gas mixture. In one illustrative example aspect, the first gas source can contain a mixture of gases including, but not limited to, fluorine, argon and neon. In some examples, the first gas source and the second gas source can be coupled to the first laser discharge chamber 404 and the second laser discharge chamber 408, respectively, through one or more valves controlled by the one or more gas control systems.

In some aspects, the example laser source 400 can include one or more temperature control systems including one or more temperature actuators configured to control independently the gas temperature in the first laser discharge chamber 404 and the gas temperature in the second laser discharge chamber 408. In some aspects, the one or more temperature control systems can include a first temperature control system that includes: one or more temperature sensors disposed in or near the first laser discharge chamber 404 and configured to detect the gas temperature in the first laser discharge chamber 404; and a first temperature actuator configured to control the gas temperature in the first laser discharge chamber 404 independent from the gas temperature in the second laser discharge chamber 408. In some aspects, the one or more temperature control systems can further include a second temperature control system that includes: one or more temperature sensors disposed in or near the second laser discharge chamber 408 and configured to detect the gas temperature in the second laser discharge chamber 408; and a second temperature actuator configured to control the gas temperature in the second laser discharge chamber 408 independent from the gas temperature in the first laser discharge chamber 404. In some aspects, the first temperature control system and the second temperature control system can provide for independent operation for the first laser discharge chamber 404 and the second laser discharge chamber 408, respectively.

In some aspects, the one or more temperature actuators can include one or more heating systems including, but not limited to, one or more coils configured to add heat to the gas in a corresponding laser discharge chamber. The one or more coils can be implemented as one or more resistive loads configured to generate heat proportional to the square of one or more applied voltages. In some aspects, the one or more temperature actuators can further include one or more cooling systems including, but not limited to, one or more fluid channels configured to remove heat from the gas in the corresponding laser discharge chamber. The one or more fluid channels can be implemented as one or more water pipes coupled to one or more valves configured to remove heat by controlling the fluid flow rate of the one or more water pipes.

In some aspects, the first laser discharge chamber 404 can include a first temperature actuator including a first heating system and a first cooling system. The first temperature actuator can be configured to control the temperature of the gas in the first laser discharge chamber 404. In some aspects, the second laser discharge chamber 408 can include a second temperature actuator including a second heating system and a second cooling system. The second temperature actuator can be configured to control the temperature of the gas in the second laser discharge chamber 408.

In some aspects, the first temperature actuator can be configured to control, using the first heating system and the first cooling system, the gas temperature in the first laser discharge chamber 404 based on: the gas temperature detected (e.g., by the one or more temperature sensors disposed in or near the first laser discharge chamber 404) in the first laser discharge chamber 404; and one or more temperature set points set (e.g., input by a user or determined by the first temperature control system) for the gas temperature in the first laser discharge chamber 404; and independent of the gas temperature in the second laser discharge chamber 408. In some aspects, the second temperature actuator can be configured to control, using the second heating system and the second cooling system, the gas temperature in the second laser discharge chamber 408 based on: the gas temperature detected (e.g., by the one or more temperature sensors disposed in or near the second laser discharge chamber 408) in the second laser discharge chamber 408; and one or more temperature set points set (e.g., input by a user or determined by the second temperature control system) for the gas temperature in the second laser discharge chamber 408; and independent of the gas temperature in the first laser discharge chamber 404.

In some aspects, the example laser source 400 can include an example laser control system 402 configured to control independently the voltage and timing of a first pulse powertrain coupled to, or associated with, the first laser discharge chamber 404 and a second pulse powertrain coupled to, or associated with, the second laser discharge chamber 408. In some aspects, the example laser control system 402 can be configured to reduce the power consumption of the first pulse powertrain, the second pulse powertrain, or both.

In some aspects, the example laser control system 402 can provide three different configurations for the example laser source 400: (i) MOPA; (ii) MOPRA; and (iii) two independent lasers. For example, when the example laser control system 402 is configured to provide a MOPA configuration for the example laser source 400, the first laser discharge chamber 404 can be an MO laser discharge chamber and the second laser discharge chamber 408 can be a PA laser discharge chamber. In another example, when the example laser control system 402 is configured to provide a MOPRA configuration for the example laser source 400, the first laser discharge chamber 404 can be an MO laser discharge chamber and the second laser discharge chamber 408 can be a PRA laser discharge chamber. In yet another example, when the example laser control system 402 is configured to provide a “two independent lasers” configuration for the example laser source 400, the first laser discharge chamber 404 can include a first laser device configured to generate a first set of photons based on the first RCS output voltage 480 (e.g., based on the first commutator output voltage 482), and the second laser discharge chamber 408 can include a second laser device configured to generate a second set of photons based on the second RCS output voltage 484 (e.g., based on the second commutator output voltage 486).

In some aspects, the example laser control system 402 can include a common RCS 420, a first commutator 434 (e.g., an MO commutator), a second commutator 438 (e.g., a PR commutator or a PRA commutator), a voltage controller 440 (e.g., FCP/FCC), a laser discharge chamber timing controller 442 (e.g., TEM), and a common HVPS 446. In some aspects, the common RCS 420 can include a first independent circuit 422, a second independent circuit 424, and a common reservoir capacitor 426. In some aspects, the first independent circuit 422 can include a first independent charging and voltage regulation circuit, and the second independent circuit 424 can include a second independent charging and voltage regulation circuit.

In some aspects, the common reservoir capacitor 426 can be configured to be electrically coupled to the first independent circuit 422 and the second independent circuit 424. In some aspects, the first independent circuit 422 and the second independent circuit 424 can share the common reservoir capacitor 426, which can be charged by the common HVPS 446. For example, the common HVPS 446 can be configured to transmit a high voltage signal 488 to the common reservoir capacitor 426. The common reservoir capacitor 426 can be configured to receive the high voltage signal 488 from the common HVPS 446 and charge the first independent circuit 422 and the second independent circuit 424 based on the high voltage signal 488.

In some aspects, the example laser control system 402 can include a first pulsed powertrain including the first independent circuit 422. The first independent circuit 422 can be configured to generate a first RCS output voltage 480 configured to drive the first laser discharge chamber 404 independent from the second laser discharge chamber 408. In some aspects, the first RCS output voltage 480 can be configured to drive the first laser discharge chamber 404 via the first commutator 434, a first commutator output voltage 482, and the first compression head 412. For example, the first independent circuit 422 can be configured to transmit the first RCS output voltage 480 to the first commutator 434. Subsequently, the first commutator 434 can be configured to receive the first RCS output voltage 480 from the first independent circuit 422, generate the first commutator output voltage 482 based on the first RCS output voltage 480, and transmit the first commutator output voltage 482 to the first compression head 412 for use in driving the first laser discharge chamber 404.

In some aspects, the example laser control system 402 can further include a second pulsed powertrain including the second independent circuit 424. The second independent circuit 424 can be configured to generate a second RCS output voltage 484 independent from the first RCS output voltage 480 configured to drive the second laser discharge chamber 408 independent from the first laser discharge chamber 404. In some aspects, the second RCS output voltage 484 can be configured to drive the second laser discharge chamber 408 via the second commutator 438, a second commutator output voltage 486, and the second compression head 414. For example, the second independent circuit 424 can be configured to transmit the second RCS output voltage 484 to the second commutator 438. Subsequently, the second commutator 438 can be configured to receive the second RCS output voltage 484 from the second independent circuit 424, generate a second commutator output voltage 486 based on the second RCS output voltage 484, and transmit the second commutator output voltage 486 to the second compression head 414 for use in driving the second laser discharge chamber 408.

In some aspects, the example laser control system 402 can include a plurality of communications interfaces, such as communications interface 460 (e.g., disposed in, coupled to, or associated with the common HVPS 446), communications interface 462 (e.g., disposed in, coupled to, or associated with the second commutator 438), communications interface 464 (e.g., disposed in, coupled to, or associated with the common RCS 420), communications interface 466 (e.g., disposed in, coupled to, or associated with the first commutator 434), and communications interface 468 (e.g., disposed in, coupled to, or associated with the common RCS 420). In some aspects, the common RCS 420 can further include: a first communications interface (e.g., one of the communications interface 464 or the communications interface 468) configured to be electrically coupled to the first independent circuit 422; and a second communications interface (e.g., the other of the communications interface 464 or the communications interface 468) configured to be electrically coupled to the second independent circuit 424. In some aspects, the plurality of communications interfaces (e.g., communications interface 460, communications interface 462, communications interface 464, communications interface 466, and communications interface 468) can be, or include, a plurality of digital communications interfaces, a plurality of controller area network (CAN) nodes, a plurality of Ethernet nodes, a plurality of serial or parallel communication cable nodes, a plurality of general-purpose interface bus (GPIB) nodes, or a plurality of any other suitable communications interfaces.

In some aspects, the voltage controller 440 can be electrically coupled to the common RCS 420 and, more specifically, the first independent circuit 422 and the second independent circuit 424 via the communications interface 464 and the communications interface 468, respectively. In some aspects, the voltage controller 440 can be configured to control independently the voltage of the first pulse powertrain (e.g., by controlling the voltage of the first RCS output voltage 480) and the voltage of the second pulse powertrain (e.g., by controlling the voltage of the second RCS output voltage 484). In some aspects, the voltage controller 440 can be configured to generate and transmit a first voltage control signal to the communications interface 464 to control independently the voltage of the first RCS output voltage 480. In some aspects, the voltage controller 440 can be configured to generate and transmit a second voltage control signal to the communications interface 468 to control independently the voltage of the second RCS output voltage 484.

In some aspects, the laser discharge chamber timing controller 442 can be electrically coupled to the first commutator 434 and the second commutator 438 via the communications interface 466 and the communications interface 462, respectively. In some aspects, the laser discharge chamber timing controller 442 can be configured to control independently the timing of the discharge of the first pulse powertrain (e.g., by controlling the timing of the first commutator output voltage 482) and the timing of the discharge of the second pulse powertrain (e.g., by controlling the timing of the second commutator output voltage 486). In some aspects, the laser discharge chamber timing controller 442 can be configured to generate and transmit a first timing control signal to the communications interface 466 to control independently the timing of the first commutator output voltage 482. In some aspects, the laser discharge chamber timing controller 442 can be configured to generate and transmit a second timing control signal to the communications interface 462 to control independently the timing of the second commutator output voltage 486.

In some aspects, the example laser control system 402 can provide three different modes of operation for the example laser source 400: (i) single pulsed powertrain operation of either the first pulsed powertrain or the second pulsed powertrain; (ii) synchronized dual pulsed powertrain operation (including, but not limited to, simultaneous dual pulsed powertrain operation) for the first pulsed powertrain and the second pulsed powertrain; and (iii) interleaved dual pulsed powertrain operation (including, but not limited to, stutter dual pulsed powertrain operation) for the first pulsed powertrain and the second pulsed powertrain. In some aspects, the example laser control system 402 can provide for independent control (e.g., independent voltage control, independent timing control, independent gas control, independent blower control, independent temperature control, or a combination thereof) of each pulsed powertrain to allow for the three modes of operation: (i) single pulsed powertrain operation of either the first laser discharge chamber 404 or the second laser discharge chamber 408; (ii) synchronized dual output (including, but not limited to, simultaneous dual output) from the first laser discharge chamber 404 and the second laser discharge chamber 408 with independent voltage operation; or (iii) interleaved dual output (including, but not limited to, stutter dual output) from the first laser discharge chamber 404 and the second laser discharge chamber 408 with independent voltage operation.

In some aspects, the example laser control system 402 can be configured to control independently the voltage and timing of the first pulsed powertrain and the voltage and timing of the second pulsed powertrain. For example, the example laser control system 402 can be configured to control independently a first voltage of the first pulsed powertrain (e.g., using the voltage controller 440 and the communications interface 464) and a second voltage of the second pulsed powertrain (e.g., using the voltage controller 440 and the communications interface 468). The example laser control system 402 can be further configured to control independently a first timing of the first pulsed powertrain (e.g., using the laser discharge chamber timing controller 442 and the communications interface 466) and a second timing of the second pulsed powertrain (e.g., using the laser discharge chamber timing controller 442 and the communications interface 462).

In some aspects, the example laser control system 402 can be configured to control independently the voltage of the first pulsed powertrain and the voltage of the second pulsed powertrain and further to control the timing of the second pulsed powertrain based on the timing of the first pulsed powertrain. For example, the example laser control system 402 can be configured to control independently a first voltage of the first pulsed powertrain (e.g., using the voltage controller 440 and the communications interface 464) and a second voltage of the second pulsed powertrain (e.g., using the voltage controller 440 and the communications interface 468). The example laser control system 402 can be further configured to control a first timing of the first pulsed powertrain (e.g., using the laser discharge chamber timing controller 442 and the communications interface 466). The example laser control system 402 can be further configured to control a second timing of the second pulsed powertrain (e.g., using the laser discharge chamber timing controller 442 and the communications interface 462) based on the first timing of the first pulsed powertrain. In one illustrative example, the example laser control system 402 can be configured to control the second timing of the second pulsed powertrain based on a delay (e.g., a discrete duration of time) with respect to the first timing of the first pulsed powertrain. In some aspects, the delay can be based on (e.g., equal to, a multiple of, a fraction of) a light propagation time between the first laser discharge chamber 404 and the second laser discharge chamber 408. In some aspects, the delay can be a controllable parameter. In some aspects, the delay can be based on a desired bandwidth of light produced by the second laser discharge chamber 408. In some aspects, the delay can be greater than about 1.0 femtosecond, 1.0 picosecond, 1.0 nanosecond, 0.1 millisecond, 1.0 millisecond, 1 second, or 10 seconds.

In some aspects, the example laser control system 402 can be configured, with a first operating mode, to trigger the second pulsed powertrain to be simultaneous with the first pulsed powertrain. The first operating mode can be configured to provide, for example, a synchronized dual pulsed powertrain operation for the first pulsed powertrain and the second pulsed powertrain, or any other suitable operation or combination of operations. In some aspects, the example laser control system 402 can be configured, with a second operating mode, to trigger the first pulsed powertrain to be delayed with respect to the second pulsed powertrain. The second operating mode can be configured to provide, for example, an interleaved dual pulsed powertrain operation for the first pulsed powertrain and the second pulsed powertrain, or any other suitable operation or combination of operations.

### Example Laser Control System Having Dual RCSs, Dual Reservoir Capacitors, and a Single HVPS

FIG. 5 is a schematic illustration of an example laser source 500 that includes an example laser control system 502 (e.g., an independent voltage pulsed power system) according to some aspects of the present disclosure. In some aspects, the example laser control system 502 can include dual independent charging and voltage regulation circuits (e.g., first independent circuit 522 and second independent circuit 524) together with dual RCSs (e.g., first RCS 520 and second RCS 521), dual reservoir capacitors (e.g., first reservoir capacitor 526 and second reservoir capacitor 527), and a single HVPS (e.g., common HVPS 546). In some aspects, the example laser source 500 can be used as part of, or in addition to, radiation source SO of lithographic apparatus 100 or 100′. Additionally, or alternatively, the example laser source 500 can generate DUV radiation to be used in DUV lithography.

As illustrated in FIG. 5, the example laser source 500 can be a dual chamber laser source that includes a dual pulsed power system with independent voltage and timing control and, in some instances, reduced power consumption. For example, the example laser source 500 can include a first laser discharge chamber 504 configured to generate a first laser beam 506 and a second laser discharge chamber 508 configured to receive the first laser beam 506 and amplify the first laser beam 506 to generate a second laser beam 510. The example laser source 500 can output the second laser beam 510, or a modified version thereof, to a lithographic apparatus (e.g., lithographic apparatus 100 or 110′). Although some aspects discussed with reference to the example laser source 500 include two laser discharge chambers, the aspects of this disclosure can be applied to laser sources that include a single laser discharge chamber or multiple laser discharge chambers.

In some aspects, the second laser discharge chamber 508 can be configured to receive and amplify light from the first laser discharge chamber 504. In some aspects, the first laser discharge chamber 504 can be implemented as part of a master oscillator (MO), and the second laser discharge chamber 508 can be implemented as part of a power amplifier (PA) or a power ring amplifier (PRA). For example, the example laser source 500 can be a MOPA laser source that includes a MO and a PA, where the MO includes the first laser discharge chamber 504 and the PA includes the second laser discharge chamber 508. In another example, the example laser source 500 can be a MOPRA laser source that includes a MO and a PRA, where the MO includes the first laser discharge chamber 504 and the PRA includes the second laser discharge chamber 508. In some aspects, the example laser source 500 can include one or more compression heads. For example, the example laser source 500 can include a first compression head 512 coupled to the first laser discharge chamber 504, and the example laser source 500 can further include a second compression head 514 coupled to the second laser discharge chamber 508. In some aspects, the first laser discharge chamber 504 and the second laser discharge chamber 508 can include, or be coupled to, any aspect, structure, feature, component, or system discussed above with reference to the example laser source 400 described with reference to FIG. 4.

In some aspects, the example laser source 500 can include an example laser control system 502 configured to control independently the voltage and timing of a first pulse powertrain coupled to, or associated with, the first laser discharge chamber 504 and a second pulse powertrain coupled to, or associated with, the second laser discharge chamber 508. In some aspects, the example laser control system 502 can be configured to reduce the power consumption of the first pulse powertrain, the second pulse powertrain, or both.

In some aspects, the example laser control system 502 can provide three different configurations for the example laser source 500: (i) MOPA; (ii) MOPRA; and (iii) two independent lasers. For example, when the example laser control system 502 is configured to provide a MOPA configuration for the example laser source 500, the first laser discharge chamber 504 can be an MO laser discharge chamber and the second laser discharge chamber 508 can be a PA laser discharge chamber. In another example, when the example laser control system 502 is configured to provide a MOPRA configuration for the example laser source 500, the first laser discharge chamber 504 can be an MO laser discharge chamber and the second laser discharge chamber 508 can be a PRA laser discharge chamber. In yet another example, when the example laser control system 502 is configured to provide a “two independent lasers” configuration for the example laser source 500, the first laser discharge chamber 504 can include a first laser device configured to generate a first set of photons based on the first RCS output voltage 580 (e.g., based on the first commutator output voltage 582), and the second laser discharge chamber 508 can include a second laser device configured to generate a second set of photons based on the second RCS output voltage 584 (e.g., based on the second commutator output voltage 586).

In some aspects, the example laser control system 502 can include a first RCS 520, a second RCS 521 a first commutator 534 (e.g., an MO commutator), a second commutator 538 (e.g., a PR commutator or a PRA commutator), a voltage controller 540 (e.g., FCP/FCC), a laser discharge chamber timing controller 542 (e.g., TEM), and a common HVPS 546. In some aspects, the first RCS 520 can include a first independent circuit 522 and a first reservoir capacitor 526, and the second RCS 521 can include a second independent circuit 524 and a second reservoir capacitor 527. In some aspects, the first independent circuit 522 can include a first independent charging and voltage regulation circuit, and the second independent circuit 524 can include a second independent charging and voltage regulation circuit.

In some aspects, the first reservoir capacitor 526 can be configured to be electrically coupled to the first independent circuit 522, and the second reservoir capacitor 527 can be configured to be electrically coupled to the second independent circuit 524. In some aspects, the first reservoir capacitor 526 and the second reservoir capacitor 527 can be charged by the common HVPS 546. For example, the common HVPS 546 can be configured to transmit a high voltage signal 588 to the first reservoir capacitor 526 and the second reservoir capacitor 527. The first reservoir capacitor 526 can be configured to receive the high voltage signal 588 from the common HVPS 546 and charge the first independent circuit 522 based on the high voltage signal 588, and the second reservoir capacitor 527 can be configured to receive the high voltage signal 588 from the common HVPS 546 and charge the second independent circuit 524 based on the high voltage signal 588.

In some aspects, the example laser control system 502 can include a first pulsed powertrain including the first independent circuit 522. The first independent circuit 522 can be configured to generate a first RCS output voltage 580 configured to drive the first laser discharge chamber 504 independent from the second laser discharge chamber 508. In some aspects, the first RCS output voltage 580 can be configured to drive the first laser discharge chamber 504 via the first commutator 534, a first commutator output voltage 582, and the first compression head 512. For example, the first independent circuit 522 can be configured to transmit the first RCS output voltage 580 to the first commutator 534. Subsequently, the first commutator 534 can be configured to receive the first RCS output voltage 580 from the first independent circuit 522, generate the first commutator output voltage 582 based on the first RCS output voltage 580, and transmit the first commutator output voltage 582 to the first compression head 512 for use in driving the first laser discharge chamber 504.

In some aspects, the example laser control system 502 can further include a second pulsed powertrain including the second independent circuit 524. The second independent circuit 524 can be configured to generate a second RCS output voltage 584 independent from the first RCS output voltage 580 configured to drive the second laser discharge chamber 508 independent from the first laser discharge chamber 504. In some aspects, the second RCS output voltage 584 can be configured to drive the second laser discharge chamber 508 via the second commutator 538, a second commutator output voltage 586, and the second compression head 514. For example, the second independent circuit 524 can be configured to transmit the second RCS output voltage 584 to the second commutator 538. Subsequently, the second commutator 538 can be configured to receive the second RCS output voltage 584 from the second independent circuit 524, generate a second commutator output voltage 586 based on the second RCS output voltage 584, and transmit the second commutator output voltage 586 to the second compression head 514 for use in driving the second laser discharge chamber 508.

In some aspects, the example laser control system 502 can include a plurality of communications interfaces, such as communications interface 560 (e.g., disposed in, coupled to, or associated with the common HVPS 546), communications interface 562 (e.g., disposed in, coupled to, or associated with the second commutator 538), communications interface 568 (e.g., disposed in, coupled to, or associated with the second RCS 521), communications interface 564 (e.g., disposed in, coupled to, or associated with the first RCS 520), and communications interface 566 (e.g., disposed in, coupled to, or associated with the first commutator 534). In some aspects, the first RCS 520 can include the communications interface 564, which can be configured to be electrically coupled to the first independent circuit 522. In some aspects, the second RCS 521 can include the communications interface 568, which can be configured to be electrically coupled to the second independent circuit 524. In some aspects, the plurality of communications interfaces (e.g., communications interface 560, communications interface 562, communications interface 564, communications interface 566, and communications interface 568) can be, or include, a plurality of digital communications interfaces, a plurality of CAN nodes, a plurality of Ethernet nodes, a plurality of serial or parallel communication cable nodes, a plurality of GPIB nodes, or a plurality of any other suitable communications interfaces.

In some aspects, the voltage controller 540 can be electrically coupled to the first RCS 520 and the second RCS 521 via the communications interface 564 and the communications interface 568, respectively. In some aspects, the voltage controller 540 can be configured to control independently the voltage of the first pulse powertrain (e.g., by controlling the voltage of the first RCS output voltage 580) and the voltage of the second pulse powertrain (e.g., by controlling the voltage of the second RCS output voltage 584). In some aspects, the voltage controller 540 can be configured to generate and transmit a first voltage control signal to the communications interface 564 to control independently the voltage of the first RCS output voltage 580. In some aspects, the voltage controller 540 can be configured to generate and transmit a second voltage control signal to the communications interface 568 to control independently the voltage of the second RCS output voltage 584.

In some aspects, the laser discharge chamber timing controller 542 can be electrically coupled to the first commutator 534 and the second commutator 538 via the communications interface 566 and the communications interface 562, respectively. In some aspects, the laser discharge chamber timing controller 542 can be configured to control independently the timing of the discharge of the first pulse powertrain (e.g., by controlling the timing of the first commutator output voltage 582) and the timing of the discharge of the second pulse powertrain (e.g., by controlling the timing of the second commutator output voltage 586). In some aspects, the laser discharge chamber timing controller 542 can be configured to generate and transmit a first timing control signal to the communications interface 566 to control independently the timing of the first commutator output voltage 582. In some aspects, the laser discharge chamber timing controller 542 can be configured to generate and transmit a second timing control signal to the communications interface 562 to control independently the timing of the second commutator output voltage 586.

In some aspects, the example laser control system 502 can provide three different modes of operation for the example laser source 500: (i) single pulsed powertrain operation of either the first pulsed powertrain or the second pulsed powertrain; (ii) synchronized dual pulsed powertrain operation (including, but not limited to, simultaneous dual pulsed powertrain operation) for the first pulsed powertrain and the second pulsed powertrain; and (iii) interleaved dual pulsed powertrain operation (including, but not limited to, stutter dual pulsed powertrain operation) for the first pulsed powertrain and the second pulsed powertrain. In some aspects, the example laser control system 502 can provide for independent control (e.g., independent voltage control, independent timing control, independent gas control, independent blower control, independent temperature control, or a combination thereof) of each pulsed powertrain to allow for the three modes of operation: (i) single pulsed powertrain operation of either the first laser discharge chamber 504 or the second laser discharge chamber 508; (ii) synchronized dual output (including, but not limited to, simultaneous dual output) from the first laser discharge chamber 504 and the second laser discharge chamber 508 with independent voltage operation; or (iii) interleaved dual output (including, but not limited to, stutter dual output) from the first laser discharge chamber 504 and the second laser discharge chamber 508 with independent voltage operation.

In some aspects, the example laser control system 502 can be configured to control independently the voltage and timing of the first pulsed powertrain and the voltage and timing of the second pulsed powertrain. For example, the example laser control system 502 can be configured to control independently a first voltage of the first pulsed powertrain (e.g., using the voltage controller 540 and the communications interface 564) and a second voltage of the second pulsed powertrain (e.g., using the voltage controller 540 and the communications interface 568). The example laser control system 502 can be further configured to control independently a first timing of the first pulsed powertrain (e.g., using the laser discharge chamber timing controller 542 and the communications interface 566) and a second timing of the second pulsed powertrain (e.g., using the laser discharge chamber timing controller 542 and the communications interface 562).

In some aspects, the example laser control system 502 can be configured to control independently the voltage of the first pulsed powertrain and the voltage of the second pulsed powertrain and further to control the timing of the second pulsed powertrain based on the timing of the first pulsed powertrain. For example, the example laser control system 502 can be configured to control independently a first voltage of the first pulsed powertrain (e.g., using the voltage controller 540 and the communications interface 564) and a second voltage of the second pulsed powertrain (e.g., using the voltage controller 540 and the communications interface 568). The example laser control system 502 can be further configured to control a first timing of the first pulsed powertrain (e.g., using the laser discharge chamber timing controller 542 and the communications interface 566). The example laser control system 502 can be further configured to control a second timing of the second pulsed powertrain (e.g., using the laser discharge chamber timing controller 542 and the communications interface 562) based on the first timing of the first pulsed powertrain. In one illustrative example, the example laser control system 502 can be configured to control the second timing of the second pulsed powertrain based on a delay (e.g., a discrete duration of time) with respect to the first timing of the first pulsed powertrain. In some aspects, the delay can be based on (e.g., equal to, a multiple of, a fraction of) a light propagation time between the first laser discharge chamber 504 and the second laser discharge chamber 508. In some aspects, the delay can be a controllable parameter. In some aspects, the delay can be based on a desired bandwidth of light produced by the second laser discharge chamber 508. In some aspects, the delay can be greater than about 1.0 femtosecond, 1.0 picosecond, 1.0 nanosecond, 0.1 millisecond, 1.0 millisecond, 1 second, or 10 seconds.

In some aspects, the example laser control system 502 can be configured, with a first operating mode, to trigger the second pulsed powertrain to be simultaneous with the first pulsed powertrain. The first operating mode can be configured to provide, for example, a synchronized dual pulsed powertrain operation for the first pulsed powertrain and the second pulsed powertrain, or any other suitable operation or combination of operations. In some aspects, the example laser control system 502 can be configured, with a second operating mode, to trigger the first pulsed powertrain to be delayed with respect to the second pulsed powertrain. The second operating mode can be configured to provide, for example, an interleaved dual pulsed powertrain operation for the first pulsed powertrain and the second pulsed powertrain, or any other suitable operation or combination of operations.

### Example Laser Control System Having Dual RCSs, Dual Reservoir Capacitors, and Dual HVPSs

FIG. 6 is a schematic illustration of an example laser source 600 that includes an example laser control system 602 (e.g., an independent voltage pulsed power system) according to some aspects of the present disclosure. In some aspects, the example laser control system 602 can include dual independent charging and voltage regulation circuits (e.g., first independent circuit 622 and second independent circuit 624) together with dual RCSs (e.g., first RCS 620 and second RCS 621), dual reservoir capacitors (e.g., first reservoir capacitor 626 and second reservoir capacitor 627), and dual HVPSs (e.g., first HVPS 646 and second HVPS 647). In some aspects, the example laser source 600 can be used as part of, or in addition to, radiation source SO of lithographic apparatus 100 or 100′. Additionally, or alternatively, the example laser source 600 can generate DUV radiation to be used in DUV lithography.

As illustrated in FIG. 6, the example laser source 600 can be a dual chamber laser source that includes a dual pulsed power system with independent voltage and timing control and, in some instances, reduced power consumption. For example, the example laser source 600 can include a first laser discharge chamber 604 configured to generate a first laser beam 606 and a second laser discharge chamber 608 configured to receive the first laser beam 606 and amplify the first laser beam 606 to generate a second laser beam 610. The example laser source 600 can output the second laser beam 610, or a modified version thereof, to a lithographic apparatus (e.g., lithographic apparatus 100 or 110′). Although some aspects discussed with reference to the example laser source 600 include two laser discharge chambers, the aspects of this disclosure can be applied to laser sources that include a single laser discharge chamber or multiple laser discharge chambers.

In some aspects, the second laser discharge chamber 608 can be configured to receive and amplify light from the first laser discharge chamber 604. In some aspects, the first laser discharge chamber 604 can be implemented as part of a master oscillator (MO), and the second laser discharge chamber 608 can be implemented as part of a power amplifier (PA) or a power ring amplifier (PRA). For example, the example laser source 600 can be a MOPA laser source that includes a MO and a PA, where the MO includes the first laser discharge chamber 604 and the PA includes the second laser discharge chamber 608. In another example, the example laser source 600 can be a MOPRA laser source that includes a MO and a PRA, where the MO includes the first laser discharge chamber 604 and the PRA includes the second laser discharge chamber 608. In some aspects, the example laser source 600 can include one or more compression heads. For example, the example laser source 600 can include a first compression head 612 coupled to the first laser discharge chamber 604, and the example laser source 600 can further include a second compression head 614 coupled to the second laser discharge chamber 608. In some aspects, the first laser discharge chamber 604 and the second laser discharge chamber 608 can include, or be coupled to, any aspect, structure, feature, component, or system discussed above with reference to the example laser source 400 described with reference to FIG. 4.

In some aspects, the example laser source 600 can include an example laser control system 602 configured to control independently the voltage and timing of a first pulse powertrain coupled to, or associated with, the first laser discharge chamber 604 and a second pulse powertrain coupled to, or associated with, the second laser discharge chamber 608. In some aspects, the example laser control system 602 can be configured to reduce the power consumption of the first pulse powertrain, the second pulse powertrain, or both.

In some aspects, the example laser control system 602 can provide three different configurations for the example laser source 600: (i) MOPA; (ii) MOPRA; and (iii) two independent lasers. For example, when the example laser control system 602 is configured to provide a MOPA configuration for the example laser source 600, the first laser discharge chamber 604 can be an MO laser discharge chamber and the second laser discharge chamber 608 can be a PA laser discharge chamber. In another example, when the example laser control system 602 is configured to provide a MOPRA configuration for the example laser source 600, the first laser discharge chamber 604 can be an MO laser discharge chamber and the second laser discharge chamber 608 can be a PRA laser discharge chamber. In yet another example, when the example laser control system 602 is configured to provide a “two independent lasers” configuration for the example laser source 600, the first laser discharge chamber 604 can include a first laser device configured to generate a first set of photons based on the first RCS output voltage 680 (e.g., based on the first commutator output voltage 682), and the second laser discharge chamber 608 can include a second laser device configured to generate a second set of photons based on the second RCS output voltage 684 (e.g., based on the second commutator output voltage 686).

In some aspects, the example laser control system 602 can include a first RCS 620, a second RCS 621 a first commutator 634 (e.g., an MO commutator), a second commutator 638 (e.g., a PR commutator or a PRA commutator), a voltage controller 640 (e.g., FCP/FCC), a laser discharge chamber timing controller 642 (e.g., TEM), a first HVPS 646, and a second HVPS 647. In some aspects, the first RCS 620 can include a first independent circuit 622 and a first reservoir capacitor 626, and the second RCS 621 can include a second independent circuit 624 and a second reservoir capacitor 627. In some aspects, the first independent circuit 622 can include a first independent charging and voltage regulation circuit, and the second independent circuit 624 can include a second independent charging and voltage regulation circuit.

In some aspects, the first reservoir capacitor 626 can be configured to be electrically coupled to the first independent circuit 622, and the second reservoir capacitor 627 can be configured to be electrically coupled to the second independent circuit 624. In some aspects, the first reservoir capacitor 626 can be charged by the first HVPS 646, and the second reservoir capacitor 627 can be charged by the second HVPS 647. For example, the first HVPS 646 can be configured to transmit a first high voltage signal 688 to the first reservoir capacitor 626, and the second HVPS 647 can be configured to transmit a second high voltage signal 689 to the second reservoir capacitor 627. The first reservoir capacitor 626 can be configured to receive the first high voltage signal 688 from the first HVPS 646 and charge the first independent circuit 622 based on the first high voltage signal 688, and the second reservoir capacitor 627 can be configured to receive the second high voltage signal 689 from the second HVPS 647 and charge the second independent circuit 624 based on the second high voltage signal 689.

In some aspects, the example laser control system 602 can include a first pulsed powertrain including the first independent circuit 622. The first independent circuit 622 can be configured to generate a first RCS output voltage 680 configured to drive the first laser discharge chamber 604 independent from the second laser discharge chamber 608. In some aspects, the first RCS output voltage 680 can be configured to drive the first laser discharge chamber 604 via the first commutator 634, a first commutator output voltage 682, and the first compression head 612. For example, the first independent circuit 622 can be configured to transmit the first RCS output voltage 680 to the first commutator 634. Subsequently, the first commutator 634 can be configured to receive the first RCS output voltage 680 from the first independent circuit 622, generate the first commutator output voltage 682 based on the first RCS output voltage 680, and transmit the first commutator output voltage 682 to the first compression head 612 for use in driving the first laser discharge chamber 604.

In some aspects, the example laser control system 602 can further include a second pulsed powertrain including the second independent circuit 624. The second independent circuit 624 can be configured to generate a second RCS output voltage 684 independent from the first RCS output voltage 680 configured to drive the second laser discharge chamber 608 independent from the first laser discharge chamber 604. In some aspects, the second RCS output voltage 684 can be configured to drive the second laser discharge chamber 608 via the second commutator 638, a second commutator output voltage 686, and the second compression head 614. For example, the second independent circuit 624 can be configured to transmit the second RCS output voltage 684 to the second commutator 638. Subsequently, the second commutator 638 can be configured to receive the second RCS output voltage 684 from the second independent circuit 624, generate a second commutator output voltage 686 based on the second RCS output voltage 684, and transmit the second commutator output voltage 686 to the second compression head 614 for use in driving the second laser discharge chamber 608.

In some aspects, the example laser control system 602 can include a plurality of communications interfaces, such as communications interface 660 (e.g., disposed in, coupled to, or associated with the first HVPS 646), communications interface 661 (e.g., disposed in, coupled to, or associated with the second HVPS 647), communications interface 662 (e.g., disposed in, coupled to, or associated with the second commutator 638), communications interface 668 (e.g., disposed in, coupled to, or associated with the second RCS 621), communications interface 664 (e.g., disposed in, coupled to, or associated with the first RCS 620), and communications interface 666 (e.g., disposed in, coupled to, or associated with the first commutator 634). In some aspects, the first RCS 620 can include the communications interface 664, which can be configured to be electrically coupled to the first independent circuit 622. In some aspects, the second RCS 621 can include the communications interface 668, which can be configured to be electrically coupled to the second independent circuit 624. In some aspects, the plurality of communications interfaces (e.g., communications interface 660, communications interface 661, communications interface 662, communications interface 664, communications interface 666, and communications interface 668) can be, or include, a plurality of digital communications interfaces, a plurality of CAN nodes, a plurality of Ethernet nodes, a plurality of serial or parallel communication cable nodes, a plurality of GPIB nodes, or a plurality of any other suitable communications interfaces.

In some aspects, the voltage controller 640 can be electrically coupled to the first RCS 620 and the second RCS 621 via the communications interface 664 and the communications interface 668, respectively. In some aspects, the voltage controller 640 can be configured to control independently the voltage of the first pulse powertrain (e.g., by controlling the voltage of the first RCS output voltage 680) and the voltage of the second pulse powertrain (e.g., by controlling the voltage of the second RCS output voltage 684). In some aspects, the voltage controller 640 can be configured to generate and transmit a first voltage control signal to the communications interface 664 to control independently the voltage of the first RCS output voltage 680. In some aspects, the voltage controller 640 can be configured to generate and transmit a second voltage control signal to the communications interface 668 to control independently the voltage of the second RCS output voltage 684.

In some aspects, the laser discharge chamber timing controller 642 can be electrically coupled to the first commutator 634 and the second commutator 638 via the communications interface 666 and the communications interface 662, respectively. In some aspects, the laser discharge chamber timing controller 642 can be configured to control independently the timing of the discharge of the first pulse powertrain (e.g., by controlling the timing of the first commutator output voltage 682) and the timing of the discharge of the second pulse powertrain (e.g., by controlling the timing of the second commutator output voltage 686). In some aspects, the laser discharge chamber timing controller 642 can be configured to generate and transmit a first timing control signal to the communications interface 666 to control independently the timing of the first commutator output voltage 682. In some aspects, the laser discharge chamber timing controller 642 can be configured to generate and transmit a second timing control signal to the communications interface 662 to control independently the timing of the second commutator output voltage 686.

In some aspects, the example laser control system 602 can provide three different modes of operation for the example laser source 600: (i) single pulsed powertrain operation of either the first pulsed powertrain or the second pulsed powertrain; (ii) synchronized dual pulsed powertrain operation (including, but not limited to, simultaneous dual pulsed powertrain operation) for the first pulsed powertrain and the second pulsed powertrain; and (iii) interleaved dual pulsed powertrain operation (including, but not limited to, stutter dual pulsed powertrain operation) for the first pulsed powertrain and the second pulsed powertrain. In some aspects, the example laser control system 602 can provide for independent control (e.g., independent voltage control, independent timing control, independent gas control, independent blower control, independent temperature control, or a combination thereof) of each pulsed powertrain to allow for the three modes of operation: (i) single pulsed powertrain operation of either the first laser discharge chamber 604 or the second laser discharge chamber 608; (ii) synchronized dual output (including, but not limited to, simultaneous dual output) from the first laser discharge chamber 604 and the second laser discharge chamber 608 with independent voltage operation; or (iii) interleaved dual output (including, but not limited to, stutter dual output) from the first laser discharge chamber 604 and the second laser discharge chamber 608 with independent voltage operation.

In some aspects, the example laser control system 602 can be configured to control independently the voltage and timing of the first pulsed powertrain and the voltage and timing of the second pulsed powertrain. For example, the example laser control system 602 can be configured to control independently a first voltage of the first pulsed powertrain (e.g., using the voltage controller 640 and the communications interface 664) and a second voltage of the second pulsed powertrain (e.g., using the voltage controller 640 and the communications interface 668). The example laser control system 602 can be further configured to control independently a first timing of the first pulsed powertrain (e.g., using the laser discharge chamber timing controller 642 and the communications interface 666) and a second timing of the second pulsed powertrain (e.g., using the laser discharge chamber timing controller 642 and the communications interface 662).

In some aspects, the example laser control system 602 can be configured to control independently the voltage of the first pulsed powertrain and the voltage of the second pulsed powertrain and further to control the timing of the second pulsed powertrain based on the timing of the first pulsed powertrain. For example, the example laser control system 602 can be configured to control independently a first voltage of the first pulsed powertrain (e.g., using the voltage controller 640 and the communications interface 664) and a second voltage of the second pulsed powertrain (e.g., using the voltage controller 640 and the communications interface 668). The example laser control system 602 can be further configured to control a first timing of the first pulsed powertrain (e.g., using the laser discharge chamber timing controller 642 and the communications interface 666). The example laser control system 602 can be further configured to control a second timing of the second pulsed powertrain (e.g., using the laser discharge chamber timing controller 642 and the communications interface 662) based on the first timing of the first pulsed powertrain. In one illustrative example, the example laser control system 602 can be configured to control the second timing of the second pulsed powertrain based on a delay (e.g., a discrete duration of time) with respect to the first timing of the first pulsed powertrain. In some aspects, the delay can be based on (e.g., equal to, a multiple of, a fraction of) a light propagation time between the first laser discharge chamber 604 and the second laser discharge chamber 608. In some aspects, the delay can be a controllable parameter. In some aspects, the delay can be based on a desired bandwidth of light produced by the second laser discharge chamber 608. In some aspects, the delay can be greater than about 1.0 femtosecond, 1.0 picosecond, 1.0 nanosecond, 0.1 millisecond, 1.0 millisecond, 1 second, or 10 seconds.

In some aspects, the example laser control system 602 can be configured, with a first operating mode, to trigger the second pulsed powertrain to be simultaneous with the first pulsed powertrain. The first operating mode can be configured to provide, for example, a synchronized dual pulsed powertrain operation for the first pulsed powertrain and the second pulsed powertrain, or any other suitable operation or combination of operations. In some aspects, the example laser control system 602 can be configured, with a second operating mode, to trigger the first pulsed powertrain to be delayed with respect to the second pulsed powertrain. The second operating mode can be configured to provide, for example, an interleaved dual pulsed powertrain operation for the first pulsed powertrain and the second pulsed powertrain, or any other suitable operation or combination of operations.

### Example Processes for Manufacturing an Apparatus

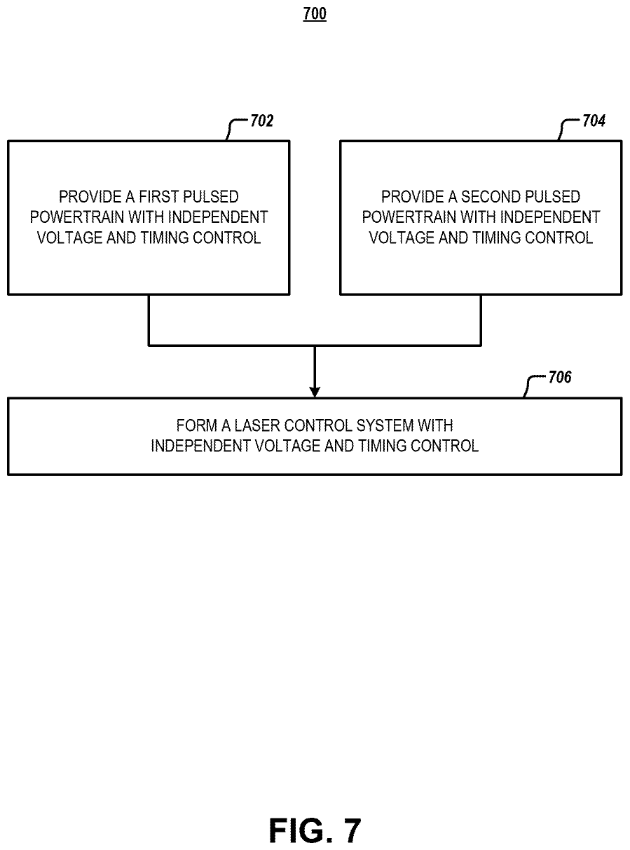

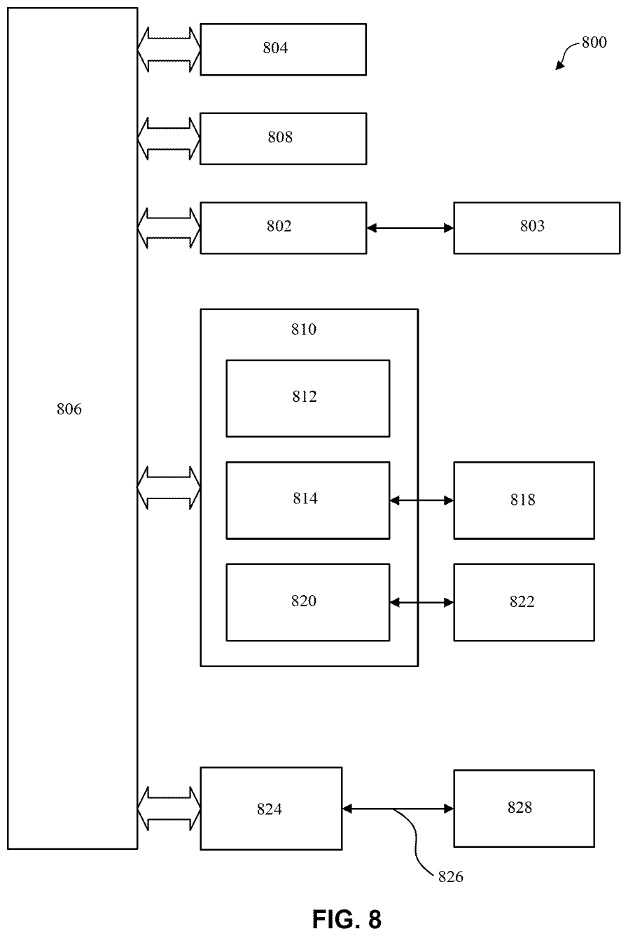

FIG. 7 is a flow chart that illustrates an example method 700 for manufacturing an apparatus according to some aspects of the present disclosure or portion(s) thereof. In some aspects, the apparatus may be, or include, a laser source, a laser control system, or a dual pulsed power system with independent voltage and timing control and, in some instances, reduced power consumption. The operations described with reference to example method 700 can be performed by, or according to, any of the systems, apparatuses, methods, computer program products, components, techniques, or combinations thereof described herein, such as those described with reference to FIGS. 1-6 above and FIG. 8 below.

At operation 702, the method can include providing a first pulsed powertrain including a first independent circuit (e.g., first independent circuit 422, 522, or 622) configured to generate a first resonant charging supply (RCS) output voltage (e.g., first RCS output voltage 480, 580, or 680). In some aspects, the first RCS output voltage can be configured to drive a first laser discharge chamber (e.g., first laser discharge chamber 404, 504, or 604). In some aspects, the providing the first pulsed powertrain can include providing the first pulsed powertrain in accordance with any aspect or combination of aspects described with reference to FIGS. 1-6 above and FIG. 8 below.

At operation 704, the method can include providing a second pulsed powertrain including a second independent circuit (e.g., second independent circuit 424, 524, or 624) configured to generate a second RCS output voltage (e.g., second RCS output voltage 484, 584, or 684) independent from the first RCS output voltage. In some aspects, the second RCS output voltage can be configured to drive a second laser discharge chamber (e.g., second laser discharge chamber 408, 508, or 608) independent from the first laser discharge chamber. In some aspects, the providing the second pulsed powertrain can include providing the second pulsed powertrain in accordance with any aspect or combination of aspects described with reference to FIGS. 1-6 above and FIG. 8 below.

At operation 706, the method can include forming a laser control system (e.g., a dual pulsed power system or an independent voltage pulsed power system, including, but not limited to, the example laser control system 402, the example laser control system 502, or the example laser control system 602) that includes the first pulsed powertrain and the second pulsed powertrain. In some aspects, the laser control system can have dual independent charging and voltage regulation circuits together with either:

(a) a single RCS, a single reservoir capacitor, and a single HVPS (e.g., the example laser control system 402 shown in FIG. 4);

(b) dual RCSs, dual reservoir capacitors, and a single HVPS (e.g., the example laser control system 502 shown in FIG. 5); or

(c) dual RCSs, dual reservoir capacitors, and dual HVPSs (e.g., the example laser control system 602 shown in FIG. 6).

In some aspects, the example laser control system can provide for three configurations: (i) a MOPA configuration where the first laser discharge chamber can be an MO laser discharge chamber and the second laser discharge chamber can be a PA laser discharge chamber; (ii) a MOPRA configuration where the first laser discharge chamber can be an MO laser discharge chamber and the second laser discharge chamber can be a PRA laser discharge chamber; or (iii) a “two independent lasers” configuration where the first laser discharge chamber can include a first laser device configured to generate a first set of photons based on the first RCS output voltage, and the second laser discharge chamber can include a second laser device configured to generate a second set of photons based on the second RCS output voltage.

In some aspects, the example laser control system can provide for independent control (e.g., independent voltage control, independent timing control, independent gas control, independent blower control, independent temperature control, or a combination thereof) of each pulsed powertrain to allow for three modes of operation: (i) single pulsed powertrain operation of either the first laser discharge chamber or the second laser discharge chamber; (ii) synchronized dual output from the first laser discharge chamber and the second laser discharge chamber with independent voltage operation; or (iii) interleaved dual output from the first laser discharge chamber and the second laser discharge chamber with independent voltage operation.

In some aspects, the forming the laser control system can include forming the laser control system in accordance with any aspect or combination of aspects described with reference to FIGS. 1-6 above and FIG. 8 below.

### Example Computing System

Aspects of the disclosure can be implemented in hardware, firmware, software, or any combination thereof. Aspects of the disclosure can also be implemented as instructions stored on a machine-readable medium, which can be read and executed by one or more processors. A machine-readable medium can include any mechanism for storing or transmitting information in a form readable by a machine (e.g., a computing device). For example, a machine-readable medium can include read only memory (ROM); random access memory (RAM); magnetic disk storage media; optical storage media; flash memory devices; electrical, optical, acoustical, or other forms of propagated signals, and others. Further, firmware, software, routines, and/or instructions may be described herein as performing certain actions. However, it should be appreciated that such descriptions are merely for convenience and that such actions in fact result from computing devices, processors, controllers, or other devices executing the firmware, software, routines, and/or instructions.

Various aspects can be implemented, for example, using one or more computing systems, such as example computing system 800 shown in FIG. 8. Example computing system 800 can be a specialized computer capable of performing the functions described herein such as: the example laser control system 402 described with reference to FIG. 4; the example laser control system 502 described with reference to FIG. 5; the example laser control system 602 described with reference to FIG. 6; any other suitable system, sub-system, or component; or any combination thereof. Example computing system 800 can include one or more processors (also called central processing units, or CPUs), such as a processor 804. Processor 804 is connected to a communication infrastructure 806 (e.g., a bus). Example computing system 800 can also include user input/output device(s) 803, such as monitors, keyboards, pointing devices, etc., that communicate with communication infrastructure 806 through user input/output interface(s) 802. Example computing system 800 can also include a main memory 808 (e.g., one or more primary storage devices), such as random access memory (RAM). Main memory 808 can include one or more levels of cache. Main memory 808 has stored therein control logic (e.g., computer software) and/or data.

Example computing system 800 can also include a secondary memory 810 (e.g., one or more secondary storage devices). Secondary memory 810 can include, for example, a hard disk drive 812 and/or a removable storage drive 814. Removable storage drive 814 can be a floppy disk drive, a magnetic tape drive, a compact disk drive, an optical storage device, tape backup device, and/or any other storage device/drive.

Removable storage drive 814 can interact with a removable storage unit 818. Removable storage unit 818 includes a computer usable or readable storage device having stored thereon computer software (control logic) and/or data. Removable storage unit 818 can be a floppy disk, magnetic tape, compact disk, DVD, optical storage disk, and/or any other computer data storage device. Removable storage drive 814 reads from and/or writes to removable storage unit 818.

According to some aspects, secondary memory 810 can include other means, instrumentalities or other approaches for allowing computer programs and/or other instructions and/or data to be accessed by example computing system 800. Such means, instrumentalities or other approaches can include, for example, a removable storage unit 822 and an interface 820. Examples of the removable storage unit 822 and the interface 820 can include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Example computing system 800 can further include a communications interface 824 (e.g., one or more network interfaces). Communications interface 824 enables example computing system 800 to communicate and interact with any combination of remote devices, remote networks, remote entities, etc. (individually and collectively referred to as remote devices 828). For example, communications interface 824 can allow example computing system 800 to communicate with remote devices 828 over communications path 826, which can be wired and/or wireless, and which can include any combination of LANs, WANs, the Internet, etc. Control logic, data, or both can be transmitted to and from example computing system 800 via communications path 826.

The operations in the preceding aspects of the present disclosure can be implemented in a wide variety of configurations and architectures. Therefore, some or all of the operations in the preceding aspects can be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, example computing system 800, main memory 808, secondary memory 810 and removable storage units 818 and 822, as well as tangible articles of manufacture embodying any combination of the foregoing. Such control logic, when executed by one or more data processing devices (such as example computing system 800), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 8. In particular, aspects of the disclosure can operate with software, hardware, and/or operating system implementations other than those described herein.

Although specific reference may be made in this text to the use of lithographic apparatus in the manufacture of ICs, it should be understood that the lithographic apparatuses described herein can have other applications, such as the manufacture of integrated optical systems, guidance and detection patterns for magnetic domain memories, flat-panel displays, LCDs, thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein can be processed, before or after exposure, in for example a track unit (a tool that typically applies a layer of resist to a substrate and develops the exposed resist), a metrology unit and/or an inspection unit. Where applicable, the disclosure herein can be applied to such and other substrate processing tools. Further, the substrate can be processed more than once, for example in order to create a multi-layer IC, so that the term substrate used herein may also refer to a substrate that already contains multiple processed layers.

It is to be understood that the phraseology or terminology herein is for the purpose of description and not of limitation, such that the terminology or phraseology of the present specification is to be interpreted by those skilled in relevant art(s) in light of the teachings herein.

The term “substrate” as used herein describes a material onto which material layers are added. In some aspects, the substrate itself can be patterned and materials added on top of it can also be patterned, or can remain without patterning.

The examples disclosed herein are illustrative, but not limiting, of the embodiments of this disclosure. Other suitable modifications and adaptations of the variety of conditions and parameters normally encountered in the field, and which would be apparent to those skilled in the relevant art(s), are within the spirit and scope of the disclosure.

Although specific reference may be made in this text to the use of the apparatus and/or system in the manufacture of ICs, it should be explicitly understood that such an apparatus and/or system has many other possible applications. For example, it can be employed in the manufacture of integrated optical systems, guidance and detection patterns for magnetic domain memories, LCD panels, thin-film magnetic heads, etc. The skilled artisan will appreciate that, in the context of such alternative applications, any use of the terms “reticle,” “wafer,” or “die” in this text should be considered as being replaced by the more general terms “mask,” “substrate,” and “target portion,” respectively.

While specific aspects of the disclosure have been described above, it will be appreciated that the aspects can be practiced otherwise than as described. The description is not intended to limit the embodiments of the disclosure.

It is to be appreciated that the Detailed Description section, and not the Background, Summary, and Abstract sections, is intended to be used to interpret the claims. The Summary and Abstract sections may set forth one or more but not all example embodiments as contemplated by the inventor(s), and thus, are not intended to limit the present embodiments and the appended claims in any way.

Some aspects of the disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects of the disclosure will so fully reveal the general nature of the aspects that others can, by applying knowledge within the skill of the art, readily modify and/or adapt for various applications such specific aspects, without undue experimentation, without departing from the general concept of the present disclosure. Therefore, such adaptations and modifications are intended to be within the meaning and range of equivalents of the disclosed aspects, based on the teaching and guidance presented herein.

Other aspects of the invention are set out in the following numbered clauses.

1. A laser control system comprising:
a first pulsed powertrain comprising a first independent circuit configured to generate a first resonant charging supply (RCS) output voltage, wherein the first RCS output voltage is configured to drive a first laser discharge chamber; and
a second pulsed powertrain comprising a second independent circuit configured to generate a second RCS output voltage independent from the first RCS output voltage, wherein the second RCS output voltage is configured to drive a second laser discharge chamber independent from the first laser discharge chamber.
2. The laser control system of clause 1, wherein the laser control system is configured to: control independently a first voltage of the first pulsed powertrain and a second voltage of the second pulsed powertrain; and
control independently a first timing of the first pulsed powertrain and a second timing of the second pulsed powertrain.
3. The laser control system of clause 1, wherein the laser control system is configured to: control independently a first voltage of the first pulsed powertrain and a second voltage of the second pulsed powertrain;
control a first timing of the first pulsed powertrain; and
control a second timing of the second pulsed powertrain based on the first timing of the first pulsed powertrain.
4. The laser control system of clause 3, wherein the laser control system is configured to:
control the second timing of the second pulsed powertrain based on a delay with respect to the first timing of the first pulsed powertrain.
5. The laser control system of clause 4, wherein the delay is based on a light propagation time between the first laser discharge chamber and the second laser discharge chamber.
6. The laser control system of clause 4, wherein the delay is a controllable parameter.
7. The laser control system of clause 4, wherein the delay is based on a desired bandwidth of light produced by the second discharge light chamber.
8. The laser control system of clause 1, wherein the laser control system is configured to: with a first operating mode, trigger the second pulsed powertrain to be simultaneous with the first pulsed powertrain; and
with a second operating mode, trigger the first pulsed powertrain to be delayed with respect to the second pulsed powertrain.
9. The laser control system of clause 1, further comprising:
a common RCS comprising the first independent circuit, the second independent circuit, and a common reservoir capacitor configured to be electrically coupled to the first independent circuit and the second independent circuit; and
a high voltage power source (HVPS) configured to transmit a high voltage signal to the common reservoir capacitor.
10. The laser control system of clause 1, further comprising:
a first RCS comprising the first independent circuit and a first reservoir capacitor configured to be electrically coupled to the first independent circuit;
a second RCS comprising the second independent circuit and a second reservoir capacitor configured to be electrically coupled to the second independent circuit; and
a high voltage power source (HVPS) configured to
transmit a first high voltage signal to the first reservoir capacitor, and
transmit a second high voltage signal to the second reservoir capacitor.
11. The laser control system of clause 1, further comprising:
a first RCS comprising the first independent circuit and a first reservoir capacitor configured to be electrically coupled to the first independent circuit;
a second RCS comprising the second independent circuit and a second reservoir capacitor configured to be electrically coupled to the second independent circuit; and
a first high voltage power source (HVPS) configured to transmit a first high voltage signal to the first reservoir capacitor; and
a second HVPS configured to transmit a second high voltage signal to the second reservoir capacitor.
12. The laser control system of clause 1, further comprising:
a first communications interface configured to be electrically coupled to the first independent circuit; and
a second communications interface configured to be electrically coupled to the second independent circuit.
13. The laser control system of clause 1, wherein the second laser discharge chamber is configured to receive and amplify light from the first laser discharge chamber.
14. The laser control system of clause 1, wherein the first laser discharge chamber is a master oscillator (MO) laser discharge chamber, and wherein the second laser discharge chamber is power amplifier (PA) discharge chamber or a power ring amplifier (PRA) discharge chamber.
15. The laser control system of clause 1, wherein the first laser discharge chamber comprises a first laser device configured to generate a first set of photons based on the first RCS output voltage, and wherein the second laser discharge chamber comprises a second laser device configured to generate a second set of photons based on the second RCS output voltage.
16. The laser control system of clause 1, wherein the laser control system is configured to provide a single pulsed powertrain operation of the first pulsed powertrain or the second pulsed powertrain.
17. The laser control system of clause 1, wherein the laser control system is configured to provide a synchronized dual pulsed powertrain operation for the first pulsed powertrain and the second pulsed powertrain.
18. The laser control system of clause 1, wherein the laser control system is configured to provide an interleaved dual pulsed powertrain operation for the first pulsed powertrain and the second pulsed powertrain.
19. An apparatus comprising:
a first pulsed powertrain comprising first independent circuit configured to generate a first resonant charging supply (RCS) output voltage, wherein the first RCS output voltage is configured to drive a first laser discharge chamber; and
a second pulsed powertrain comprising second independent circuit configured to generate a second RCS output voltage independent from the first RCS output voltage, wherein the second RCS output voltage is configured to drive a second laser discharge chamber independent from the first laser discharge chamber.
20. A method for manufacturing an apparatus, comprising:
providing a first pulsed powertrain comprising a first independent circuit configured to generate a first resonant charging supply (RCS) output voltage, wherein the first RCS output voltage is configured to drive a first laser discharge chamber;
providing a second pulsed powertrain comprising a second independent circuit configured to generate a second RCS output voltage independent from the first RCS output voltage, wherein the second RCS output voltage is configured to drive a second laser discharge chamber independent from the first laser discharge chamber; and
forming a laser control system comprising the first pulsed powertrain and the second pulsed powertrain.

The breadth and scope of the present disclosure should not be limited by any of the above-described example aspects or embodiments, but should be defined only in accordance with the following claims and their equivalents.

What is claimed is:

1. A laser control system comprising:
a first pulsed powertrain comprising a first independent circuit configured to generate a first resonant charging supply (RCS) output voltage, wherein the first RCS output voltage is configured to drive a first laser discharge chamber; and
a second pulsed powertrain comprising a second independent circuit configured to generate a second RCS output voltage independent from the first RCS output voltage, wherein the second RCS output voltage is configured to drive a second laser discharge chamber independent from the first laser discharge chamber.

2. The laser control system of claim 1, wherein the laser control system is configured to:
control independently a first voltage of the first pulsed powertrain and a second voltage of the second pulsed powertrain; and
control independently a first timing of the first pulsed powertrain and a second timing of the second pulsed powertrain.

3. The laser control system of claim 1, wherein the laser control system is configured to:
control independently a first voltage of the first pulsed powertrain and a second voltage of the second pulsed powertrain;
control a first timing of the first pulsed powertrain; and
control a second timing of the second pulsed powertrain based on the first timing of the first pulsed powertrain.

4. The laser control system of claim 3, wherein the laser control system is configured to: control the second timing of the second pulsed powertrain based on a delay with respect to the first timing of the first pulsed powertrain.

5. The laser control system of claim 4, wherein the delay is based on a light propagation time between the first laser discharge chamber and the second laser discharge chamber.

6. The laser control system of claim 4, wherein the delay is a controllable parameter.

7. The laser control system of claim 4, wherein the delay is based on a desired bandwidth of light produced by the second discharge light chamber.

8. The laser control system of claim 1, wherein the laser control system is configured to:
with a first operating mode, trigger the second pulsed powertrain to be simultaneous with the first pulsed powertrain; and
with a second operating mode, trigger the first pulsed powertrain to be delayed with respect to the second pulsed powertrain.

9. The laser control system of claim 1, further comprising:
a common RCS comprising the first independent circuit, the second independent circuit, and a common reservoir capacitor configured to be electrically coupled to the first independent circuit and the second independent circuit; and
a high voltage power source (HVPS) configured to transmit a high voltage signal to the common reservoir capacitor.

10. The laser control system of claim 1, further comprising:
a first RCS comprising the first independent circuit and a first reservoir capacitor configured to be electrically coupled to the first independent circuit;
a second RCS comprising the second independent circuit and a second reservoir capacitor configured to be electrically coupled to the second independent circuit; and
a high voltage power source (HVPS) configured to
transmit a first high voltage signal to the first reservoir capacitor, and
transmit a second high voltage signal to the second reservoir capacitor.

11. The laser control system of claim 1, further comprising:
a first RCS comprising the first independent circuit and a first reservoir capacitor configured to be electrically coupled to the first independent circuit;
a second RCS comprising the second independent circuit and a second reservoir capacitor configured to be electrically coupled to the second independent circuit; and
a first high voltage power source (HVPS) configured to transmit a first high voltage signal to the first reservoir capacitor; and
a second HVPS configured to transmit a second high voltage signal to the second reservoir capacitor.

12. The laser control system of claim 1, further comprising:
a first communications interface configured to be electrically coupled to the first independent circuit; and
a second communications interface configured to be electrically coupled to the second independent circuit.

13. The laser control system of claim 1, wherein the second laser discharge chamber is configured to receive and amplify light from the first laser discharge chamber.

14. The laser control system of claim 1, wherein the first laser discharge chamber is a master oscillator (MO) laser discharge chamber, and wherein the second laser discharge chamber is power amplifier (PA) discharge chamber or a power ring amplifier (PRA) discharge chamber.

15. The laser control system of claim 1, wherein the first laser discharge chamber comprises a first laser device configured to generate a first set of photons based on the first RCS output voltage, and wherein the second laser discharge chamber comprises a second laser device configured to generate a second set of photons based on the second RCS output voltage.

16. The laser control system of claim 1, wherein the laser control system is configured to provide a single pulsed powertrain operation of the first pulsed powertrain or the second pulsed powertrain.

17. The laser control system of claim 1, wherein the laser control system is configured to provide a synchronized dual pulsed powertrain operation for the first pulsed powertrain and the second pulsed powertrain.

18. The laser control system of claim 1, wherein the laser control system is configured to provide an interleaved dual pulsed powertrain operation for the first pulsed powertrain and the second pulsed powertrain.

19. An apparatus comprising:
a first pulsed powertrain comprising first independent circuit configured to generate a first resonant charging supply (RCS) output voltage, wherein the first RCS output voltage is configured to drive a first laser discharge chamber; and
a second pulsed powertrain comprising second independent circuit configured to generate a second RCS output voltage independent from the first RCS output voltage, wherein the second RCS output voltage is configured to drive a second laser discharge chamber independent from the first laser discharge chamber.

20. A method for manufacturing an apparatus, comprising:
providing a first pulsed powertrain comprising a first independent circuit configured to generate a first resonant charging supply (RCS) output voltage, wherein the first RCS output voltage is configured to drive a first laser discharge chamber;
providing a second pulsed powertrain comprising a second independent circuit configured to generate a second RCS output voltage independent from the first RCS output voltage, wherein the second RCS output voltage is configured to drive a second laser discharge chamber independent from the first laser discharge chamber; and
forming a laser control system comprising the first pulsed powertrain and the second pulsed powertrain.
